(19) United States
(12) Patent Application Publication
(10) Pub. No.: US 2023/0357005 A1
(43) Pub. Date: Nov. 9, 2023

(54) REDOX LOOPING SYSTEMS AND METHODS FOR PRODUCTION OF OXIDIZED PRODUCTS

(71) Applicant: OHIO STATE INNOVATION FOUNDATION, COLUMBUS, OH (US)

(72) Inventors: Liang-Shih Fan, Columbus, OH (US); Rushikesh K. Joshi, Columbus, OH (US); Eric J. Falascino, Columbus, OH (US); Dawei Wang, Columbus, OH (US)

(21) Appl. No.: 18/143,471

(22) Filed: May 4, 2023

Related U.S. Application Data
(60) Provisional application No. 63/353,797, filed on Jun. 20, 2022.
(60) Provisional application No. 63/338,212, filed on May 4, 2022.

(51) Int. Cl. B01J 19/00; B01J 19/18; C01B 3/34

(52) U.S. Cl. CPC C01B 3/344; B01J 19/0053; B01J 19/1837; C01B 2203/1241

(57) ABSTRACT

An exemplary reactor system may include a first reactor, a second reactor, a third reactor, and a fourth reactor. The first reactor may be in parallel with the second reactor and the third reactor. The second reactor and third reactor may be in series. The fourth reactor may be configured to receive reduced oxygen carriers from the other reactors, generate oxidized oxygen carriers, and provide the oxidized oxygen carriers back to the other reactors. Carbonaceous feedstock may be used within one or more reactors.

### CROSS REFERENCE TO RELATED APPLICATIONS

This application claims priority to U.S. Provisional Pat. Application No. 63/338,212, filed on May 4, 2022, and U.S. Provisional Pat. Application No. 63/353,797, filed on Jun. 20, 2022, the entire contents both of which are hereby incorporated by reference in their entirety.

### FIELD

The present disclosure is related to exemplary systems, methods, and techniques for redox looping systems. Exemplary systems and methods may use moving bed reactor systems to convert carbonaceous feedstock into oxidation products and/or syngas.

### INTRODUCTION

Syngas production from carbonaceous fuels is useful as a platform chemical in various synthesis pathways. These pathways include, at least, the production of synthetic fuels and products such as methanol, ethanol, dimethyl ether, acetic acid, hydrogen gas (H₂), etc. The use of syngas as an intermediate provides for a shift in processing between products with minimal change in upstream feed of syngas. Additionally, syngas provides for the production of energy carriers such as hydrogen, methanol and liquid fuels from non-petroleum-based products.

Providing a waste product as the source of carbon and hydrogen in the feedstock increases the sustainability of syngas production. Agricultural wastes, and biomasses in general, may be used as solid fuels for the feedstock in gasification processes for syngas production from a renewable source. However, the main disadvantage of biomass as a solid fuel is the production of tars, which may cause operability issues and requires downstream purification processes for the syngas to be commercially acceptable. These disadvantages are present when using other wastes such as post-consumer plastics and industrial wastes (i.e., used tires, petcoke, etc.). In some instances, the tars from these wastes are greater than those produced from biomass gasification.

Downstream Fischer-Tropsch (FT) processes utilize syngas as a feedstock. The tail-gas of the FT reactors and processes contain light hydrocarbons, carbon dioxide (CO₂), residual hydrogen gas (H₂), and carbon monoxide (CO). The light hydrocarbons, carbon monoxide (CO), and hydrogen gas (H₂) contain reducing potential and therefore may be used for recovering additional energy from the redox systems and methods. However, the presence of large quantities of carbon dioxide (CO₂) in the tail gas makes it more difficult to recover any additional heat from the system. As a result, the entire tails gas mixture is generally sent to an Acid Gas Removal Unit to capture the carbon dioxide (CO₂).

In traditional gasifiers that produce syngas from carbonaceous fuels, the endothermic nature of the gasification reactions requires heat to be provided into the system in order to maintain continuous operation of the system. To operate autothermally, the heat may be provided directly. In other instances, such as exothermic reactions that occur within the reactor, heat may be provided indirectly by combustion of the feedstock in a separate reactor containing a heating media that is transferred to the gasifier. During autothermal processes, the syngas quality is lower due in part to dilution with nitrogen from air which may be used as an oxidizing agent.

### SUMMARY

In one aspect, an exemplary reactor system is disclosed. An exemplary reactor system may include: a first reactor comprising: a first inlet in fluid communication with an oxidized oxygen carrier stream; a second inlet configured to receive carbonaceous feedstock; a first outlet in fluid communication with a reduced oxygen carrier stream; and a second outlet in fluid communication with one or more processes; a second reactor comprising: a first inlet in fluid communication with the oxidized oxygen carrier stream; and a first outlet; a third reactor comprising: a first inlet in fluid communication with the first outlet of the second reactor; a first outlet being in fluid communication with the reduced oxygen carrier stream; the third reactor being in series with the second reactor; and the first reactor being in parallel with the second reactor and the third reactor; and a fourth reactor comprising: an inlet in fluid communication with the reduced oxygen carrier stream; an outlet in fluid communication with the oxidized oxygen carrier stream; and the fourth reactor being configured as a fluidized bed reactor.

In another aspect, a reactor system is disclosed. An example reactor system may include: a combustor reactor; a riser in fluid communication with the combustor reactor; a first gas-sealing device in fluid communication with the riser, the first gas-sealing device being in fluid communication with an inlet of a first gas source; and an outlet of the first gas-sealing device being in fluid communication with a first reducer; a second gas-sealing device in fluid communication with the riser, the second gas-sealing device being in fluid communication with an inlet of a second gas source; and an outlet of the second gas-sealing device being in fluid communication with a second reducer; the first reducer being in fluid communication with an inlet of a third gas-sealing device, the third gas-sealing device being in fluid communication with an inlet of a third gas source; and an outlet of the third gas-sealing device being in fluid communication with the combustor; the second reducer being in fluid communication with an inlet of a fourth gas-sealing device, the fourth gas-sealing device being in fluid communication with an inlet of a fourth gas source; and an outlet of the fourth gas-sealing device being in fluid communication with an oxidizer reactor; the oxidizer reactor being in fluid communication with a fifth gas-sealing device, the fifth gas-sealing device being in fluid communication with an inlet of a fifth gas source; and an outlet of the fifth gas-sealing device being in fluid communication with the combustor.

In another aspect, a method for operating a reactor system is disclosed. An exemplary method may include generating, in a first reactor, syngas and a plurality of first reduced oxygen carriers by reacting a carbonaceous feedstock with a plurality of first oxidized oxygen carriers; providing the syngas from the first reactor to an inlet of one or more chemical processes; generating, in a second reactor, oxidation products and a plurality of second reduced oxygen carriers by reacting waste gas with a plurality of second oxidized oxygen carriers; generating, in a third reactor, hydrogen gas (H₂) and a plurality of reduced oxygen carriers by reacting oxygen-providing materials with the plurality of second reduced oxygen carriers; providing the plurality of first reduced oxygen carriers from the first reactor to a reduced oxygen carrier stream, the reduced oxygen carrier stream being in fluid communication with a fourth reactor; generating, in the fourth reactor, oxidized oxygen carriers by reacting the reduced oxygen carrier stream with air; providing oxidized oxygen carriers generated in the fourth reactor to the first reactor; and providing oxidized oxygen carriers generated in the fourth reactor to the second reactor.

### BRIEF DESCRIPTION OF THE DRAWINGS

FIG. 1 schematically shows an exemplary system for processing carbonaceous feedstock and an exemplary chemical process.

FIG. 2 schematically shows another exemplary system in fluid communication with one or more exemplary chemical processes for processing carbonaceous feedstocks.

FIG. 3 schematically shows an exemplary reactor system including a co-current first reactor, a counter-current second reactor, a counter-current third reactor and a co-current fourth reactor.

FIG. 4 schematically shows another exemplary system for processing carbonaceous feedstock.

FIG. 5 schematically shows another exemplary system including a co-current first reactor, a counter-current second reactor, a counter-current third reactor, and a co-current fourth reactor.

FIG. 6 schematically shows another exemplary system including a plurality of co-current first reactors, a counter-current second reactor, a counter-current third reactor, and a co-current fourth reactor.

FIG. 7 schematically shows another exemplary system including a cross-current first reactor, a counter-current second reactor, a counter-current third reactor, and a co-current fourth reactor.

FIG. 8 schematically shows another exemplary system including a co-current first reactor, a counter-current second reactor, a co-current third reactor, and a co-current fourth reactor.

FIG. 9 schematically shows another exemplary system including a co-current first reactor, a counter-current second reactor, a counter-current third reactor, and a co-current fourth reactor.

FIG. 10 schematically shows another exemplary system including co-current first reactor, a counter-current second reactor, a counter-current third reactor, and a fourth reactor.

FIG. 11 schematically shows another exemplary system including a co-current first reactor, a plurality of counter-current second reactors, a counter-current third reactor, and a co-current fourth reactor.

FIG. 12 schematically shows another exemplary system including co-current first reactor, a plurality of counter-current second reactors, a plurality of counter-current third reactors, and a co-current fourth reactor.

FIG. 13 schematically shows another exemplary system including a counter-current first reactor, a counter-current second reactor, a counter-current third reactor, and a co-current fourth reactor.

FIG. 14 schematically shows another exemplary system including a co-current first reactor, a counter-current second reactor, a counter-current third reactor, and a co-current fourth reactor.

FIG. 15 schematically shows another exemplary system including a co-current first reactor, a counter-current second reactor, a counter-current third reactor, a co-current fourth reactor, and a co-current fifth reactor.

FIG. 16 schematically shows an exemplary system including a combustor reactor, a riser, a first reducer reactor, a second reducer reactor, and an oxidizer reactor.

FIG. 17A schematically shows an exemplary standpipe gas-sealing device in accordance with an exemplary system.

FIG. 17B schematically shows an exemplary seal pot gas-sealing device in accordance with an exemplary system.

FIG. 18 schematically shows another exemplary system including a combustor reactor, a riser reactor, a first reducer reactor, a second reducer reactor, and an oxidizer reactor.

FIG. 19 schematically shows an exemplary system including a first reactor in fluid communication with a second reactor and a high-temperature water gas shift reactor, a third reactor in fluid communication with the second reactor, the high-temperature water gas shift reactor in fluid communication with a low-temperature water gas shift reactor, the low-temperature gas shift reactor in fluid communication with a pressure-swing adsorption reactor, and the pressure-swing adsorption reactor in fluid communication with the third reactor.

FIG. 20 shows another exemplary moving bed reactor system for processing carbonaceous feedstock.

FIG. 21 is a flowchart of a method of operating an exemplary reactor system for processing carbonaceous feedstock.

FIG. 22 is a flowchart of a method of operating another exemplary reactor system for processing carbonaceous feedstock.

FIG. 23 is a flowchart of a method of operating another exemplary reactor system for processing carbonaceous feedstock.

FIG. 24 shows thermodynamic simulation data of molar flowrate versus temperature versus OCIN flowrate for a reducer outlet gas generated using the system shown in FIG. 19.

FIG. 25 shows thermodynamic simulation data of outlet flowrate versus OCIN flowrate for reducer outlet gas generated using the system shown in FIG. 19.

FIG. 26 shows experimental data of volume percent of production gases versus time for the exemplary moving bed reactor system as shown in FIG. 20.

### DETAILED DESCRIPTION

Systems, methods, and techniques disclosed herein may provide oxidation products, hydrogen gas (H₂), and/or energy generation. Exemplary systems and methods may include a moving bed reducer reactor. Exemplary systems and methods provide for end user modularity by selecting a number and configuration of the moving bed reducer reactor, and one or more oxidizer reactors to tailor the overall system for a desired product output. Exemplary reactors may be sized according to the fuel feedstock and required residence time for production of exemplary oxidation products.

Exemplary systems and methods can be integrated with various chemical or physical processes in chemical, petrochemical, refining, mining, metallurgical, ceramic, mineral, energy, bio-allied, agriculture, or related environments that utilizes and/or generates a gas stream containing hydrogen and/or carbon-based compounds. Exemplary systems and methods may also be implemented using various reducing gas streams for recovering energy while producing a capturable carbon dioxide (CO₂) stream.

Exemplary systems and methods may include co-injection of carbonaceous feedstocks to improve the product syngas quality. For example, co-injection of coal and biomass may have synergistic effects on efficiency compared against use of single solid fuels. However, the carbonaceous feedstocks may be optimized based on the specific characteristics, such that different species exist within each genus of carbonaceous feedstocks. Similarly, biomass-waste co-injection systems may be optimized based on those specific characteristics.

Exemplary systems and methods may utilize non-renewable heat sources to provide energy for an exemplary system. Exemplary systems and methods may utilize renewable energy which may include solar energy, biomass/biogas combustion. geothermal energy, electric heating from hydropower, wind power, etc. Use of renewable energy may allow the exemplary systems and methods to be more sustainable and carbon dioxide (CO₂) negative. Use of solar power may be utilized for supplying heat to the exemplary systems and methods. Internal and/or external combustion of biogas/biomass with air may generate heat that may be supplied to the exemplary systems with or without the use of a heat transfer media.

Exemplary systems and methods may be capable of processing solid and slurry carbonaceous feedstocks to partial or full oxidation products with purities of greater than 65%. The high purity of the resulting product stream may be acceptable for downstream processes without further purification steps.

### I. Definitions

Unless otherwise defined, all technical and scientific terms used herein have the same meaning as commonly understood by one of ordinary skill in the art. In case of conflict, the present document, including definitions, will control. Example methods and materials are described below, although methods and materials similar or equivalent to those described herein can be used in practice or testing of the present disclosure. All publications, patent applications, patents and other references mentioned herein are incorporated by reference in their entirety. The materials, methods, and examples disclosed herein are illustrative only and not intended to be limiting.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “an,” and “the” include plural references unless the context clearly dictates otherwise. The present disclosure also contemplates other embodiments, “comprising,” “consisting of,” and “consisting essentially of,” the embodiments or elements presented herein, whether explicitly set forth or not.

The modifier “about” used in connection with a quantity is inclusive of the stated value and has the meaning dictated by the context (for example, it includes at least the degree of error associated with the measurement of the particular quantity). The modifier “about” should also be considered as disclosing the range defined by the absolute values of the two endpoints. For example, the expression “from about to about 4” also discloses the range “from 2 to 4.” The term “about” may refer to plus or minus 10% of the indicated number. For example, “about 10%” may indicate a rage of 9% to 11%, and “about 1” may mean from 0.9-1.1. Other meanings of “about” may be apparent from the context, such as rounding off, s, for example “about 1” may also mean from 0.5 to 1.4.

Definitions of specific functional groups and chemical terms are described in more detail below. For purposes of this disclosure, the chemical elements are identified in accordance with the Periodic Table of the Elements, CAS version, Handbook of Chemistry and Physics, 75^{th} Ed., inside cover, and specific functional groups are generally defined as described therein.

For each recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the numbers 6.0, 6.1, 6.2, 6.3, 6.4, 6.5, 6.6, 6.7, 6.8, 6.9, and 7.0 are explicitly contemplated.

A “moving bed reactor” is defined as a reactor where catalytic material flows in a single direction, generally, from top to bottom. The fluid material can flow in the same direction as the catalytic material (co-current movement). The fluid material can flow in an opposite direction as the catalytic material (countercurrent movement).

A “fluidized bed reactor” is defined as a reactor where fluid is passed through catalyst material at a sufficient speed to suspend the solid catalyst material. Typically, catalyst material may move in any direction, bounded by the walls of the reactor.

### II. Exemplary Materials

Exemplary systems and methods involve various materials, such carbonaceous feedstock, oxygen carriers, oxidizing agents, and oxidation products. Examples of each are discussed below.

### A. Exemplary Carbonaceous Feedstock

Exemplary carbonaceous feedstocks disclosed and contemplated herein are provided as a feedstock to exemplary reactors. Exemplary carbonaceous feedstocks may be introduced as individual streams, or as a mixed stream. Exemplary carbonaceous feedstocks may be provided such that the feed ratios do not result in carbon deposition onto the oxygen carriers.

Exemplary carbonaceous feedstock may include solid, liquid, or gaseous feedstocks comprising carbon and hydrogen. Exemplary carbonaceous feedstock may also include other elements such as oxygen, nitrogen, sulfur, silicon, phosphorus, potassium, sodium, etc.

In various implementations, solid fuels may include coal, biomass, petcoke, plastics, metallurgical coke, municipal solid waste, animal wastes, etc. In various implementations, the solid fuels may further include forms such as large-shredded pieces, small-shredded pieces, mixed size injection, liquified injection (i.e., a slurry), fine powders, or combinations thereof. In various implementations, systems and methods are not sensitive to the physical characteristics of the carbonaceous feedstock.

In various implementations, liquid fuels may include high-chain petroleum products, waste streams from pulp processing industries, food wastes, sewage sludge, diesel etc.

In various implementations, gaseous fuels may include natural gas, high-tar low-quality syngas, biogas, waste and tail gases from chemical, petrochemical, refining, mining, metallurgical, ceramic, mineral, energy, bio-allied, agricultural, or related environments.

### B. Exemplary Oxygen-Source Materials

Exemplary oxygen-source materials may facilitate the conversion of the carbonaceous feedstock to the exemplary oxidation products.

Exemplary oxygen-source materials may comprise compounds that include one or more oxygen atoms. In various implementations, exemplary oxygen-source materials may comprise steam (H₂O), oxygen (O₂), and/or carbon dioxide (CO₂).

In various implementations, the exemplary oxygen-source materials may result in better kinetics of the gasification reaction of the exemplary systems, where the exemplary oxygen-source materials react with the exemplary carbonaceous feedstock to generate gaseous intermediates such as CO, H₂, CO₂, and H₂O. The generated gaseous intermediates react with the exemplary oxygen carriers to generate the exemplary oxidation products.

In various implementations, carbon dioxide (CO₂) may be produced during the gasification reaction and may itself be used as the exemplary oxygen-source material in the exemplary systems.

### C. Exemplary Oxygen Carriers

Exemplary oxygen carriers are described below regarding example components, amounts, and physical properties. Exemplary oxygen carriers may be used in exemplary systems and methods for the processing carbonaceous feedstocks. Exemplary oxygen carriers disclosed and contemplated herein may include one or more constituents which comprise one or more metal oxide components, one or more support materials, one or more promoters and dopants, or one or more inert materials.

Exemplary oxygen carriers may activate the C-H bond of the carbonaceous feedstock and may cause decomposing into, at least, carbon and hydrogen gas (H₂). In various implementations, the carbon and hydrogen gas (H₂) may further react with the oxygen carrier to produce CO, CO₂, H₂O, and/or remain unconverted.

Exemplary oxygen carriers may change their oxidation state based on, at least, interaction with reducing and oxidizing gases. Exemplary oxygen carriers may provide heat transfer throughout various exemplary reactors described herein.

Exemplary oxygen carriers may provide for high heat-carrying capacity based on, at least, one or more active metal oxides (i.e., redox material) and one or more support metal oxides (i.e., an inert material), thereby providing a heat balance across the exemplary systems.

The oxidation state of exemplary oxygen carriers is an indicator of solid phases present and the oxygen carrying capacity of the oxygen carriers. The oxidation state of the exemplary oxygen carriers is defined by equation (1), shown below:

$$\begin{matrix}P e r c e n t \left(\%\right) r e d u c t i o n = \\ \frac{m a s s o f o x y g e n l o s t f r o m o x y g e n c a r r i e r d u e t o r e d u c t i o n}{m a x i m u m o x y g e n l o s s p o t e n t i a l} \times 100\end{matrix} \qquad \text{(1)}$$

As an illustrative example, if an exemplary oxygen carrier comprises ferric oxide (Fe₂O₃) as an active material, a percent reduction of Fe₂O₃ may be 0%, percent reduction of Fe₃O₄ may be 11%, percent reduction of FeO may be 33%, and percent reduction of Fe may be 100%. Accordingly, an exemplary moving bed reducer reactor may extract oxygen from an exemplary oxygen carrier leading to an increase in the percent reduction, and a fluidized bed reactor may decrease the percent reduction by oxidizing an exemplary oxygen carrier

Exemplary systems may operate such that oxygen carriers entering a moving bed reducer reactor at the inlet can have percent reduction value between 0% to 95%; 10% to 95%; 20% to 95%; 30% to 95%: 40% to 95%; 50% to 95%; 60% to 95%; 70% to 95%; 80% to95%; or 90% to 95%. The moving bed reducer reactor can then increase the percent reduction of the inlet oxygen carrier by a value between 0.5% to 99.5%, thereby reducing the oxygen carriers to a percent reduction value between 0.5% to 100%. Subsequently, exemplary fluidized bed combustors can oxidize the oxygen carriers back to a percent reduction value between 0% (fully oxidized) to 95%; 10.5% to 99.5%; 20.5% to 99.5%; 30.5% to 99.5%; 40.5% to 99.5%; 55.5% to 99.5%; 65.5% to 99.5%; 75.5% to 99.5%; 85.5% to 99.5%; or 95.5% to 99.5%; by supplying oxygen to the material. Correspondingly, the process conditions, product requirements and reaction kinetics may determine the percent reduction change across each reactor in a steady state.

### 1. Exemplary Chemical Constituents

Exemplary oxygen carriers may comprise one or more active metal oxides and/or their derivatives. Exemplary oxygen carriers are capable of undergoing cyclic reduction and oxidation, thereby providing a change in the oxidation state of one or more constituents present in the exemplary oxygen carriers. In various implementations, the one or more active metal oxides comprise transition metal oxides such as iron oxide, copper oxide, nickel oxide, manganese oxide, cobalt oxide, and combinations thereof.

In various implementations, the one or more active metal oxides may comprise 5 weight percent (wt%) to 95 wt% of the total weight of the exemplary oxygen carriers. In various implementations, the one or more active metal oxides may comprise 10 wt% to95 wt%; 15 wt% to 95 wt%; 20 wt% to 95 wt%; 25 wt% to 95 wt%; 30 wt% to 95 wt%; 35 wt% to 95 wt%; 40 wt% to 95 wt%; 45 wt% to 95 wt%; 50 wt% to 95 wt%; 55 wt% to 95 wt%; 60 wt% to 95 wt%; 65 wt% to 95 wt%; 70 wt% to 95 wt%; 75 wt% to 95 wt%; 80 wt% to 95 wt%; 85 wt% to 95 wt%; 90 wt% to 95 wt%; 5 wt% to 90 wt%; 5 wt%; to 85 wt%; 10 wt% to 85 wt%; 15 wt% to 85 wt%; 20 wt% to 85 wt%; 20 wt% to 80 wt%; 25 wt% to 80 wt%; 25 wt% to75 wt%; 30 wt% to 75 wt%; 30 wt% to 70 wt%; 35 wt% to 70 wt%; 35 wt% to 65 wt%; 40 wt% to 65 wt%; 40 wt% to 60 wt%; 45 wt% to60 wt%; 45 wt% to 55 wt%; or about 50 wt%. In various implementations, the one or more active metal oxides may comprise no less than 5 wt%; no less than 15 wt%; no less than 25 wt%; no less than 35 wt%; no less than 45 wt%; no less than 55 wt%; no less than 65 wt%; no less than 75 wt%; or no less than 85 wt% of the total weight of the exemplary oxygen carriers. In various implementations, the one or more active metal oxides may comprise no greater than 95 wt%; no greater than 90 wt%; no greater than80 wt%; no greater than 70 wt%; no greater than 60 wt%; no greater than 50 wt%; no greater than 40 wt%; no greater than 30 wt%; no greater than 20 wt%; or no greater than 10 wt% of the total weight of the exemplary oxygen carriers.

Exemplary oxygen carriers may comprise one or more support metal oxides. In various implementations, the one or more support metal oxides may comprise any known metal oxide in the art. In various implementations, the one or more support metal oxides may comprise SiO₂, SiC, Al₂O₃, MgO, CaO, alumina-silicates, ceramics, clay supports like kaolin and bentonite, alumina-zirconia-silica, or a combination comprising of two or more support materials.

In various implementations, the one or more support metal oxides may comprise 5 wt% to 95 wt% of the total weight of the exemplary oxygen carriers. In various implementations, the one or more support metal oxides may comprise 10 wt% to95 wt%; 15 wt% to 95 wt%; 20 wt% to 95 wt%; 25 wt% to 95 wt%; 30 wt% to 95 wt%; 35 wt% to 95 wt%; 40 wt% to95 wt%; 45 wt% to 95 wt%; 50 wt% to 95 wt%; 55 wt% to 95 wt%; 60 wt% to 95 wt%; 65 wt% to 95 wt%; 70 wt% to 95 wt%; 75 wt% to 95 wt%; 80 wt% to 95 wt%; 85 wt% to 95 wt%; 90 wt% to 95 wt%; 5 wt% to 90 wt%; 5 wt%; to 85 wt%; 10 wt% to 85 wt%; 15 wt% to 85 wt%; 20 wt% to 85 wt%; 20 wt% to 80 wt%; 25 wt% to 80 wt%; 25 wt% to 75 wt%; 30 wt% to 75 wt%; 30 wt% to 70 wt%; 35 wt% to 70 wt%; 35 wt% to65 wt%; 40 wt% to 65 wt%; 40 wt% to 60 wt%; 45 wt% to 60 wt%; 45 wt% to 55 wt%; or about 50 wt%. In various implementations, the one or more support metal oxides may comprise no less than 5 wt%; no less than 15 wt%; no less than 25 wt%; no less than 35 wt%; no less than45 wt%; no less than 55 wt%; no less than 65 wt%; no less than 75 wt%; or no less than 85 wt% of the total weight of the exemplary oxygen carriers. In various implementations, the one or more support metal oxides may comprise no greater than 95 wt%; no greater than 90 wt%; no greater than 80 wt%; no greater than 70 wt%; no greater than 60 wt%; no greater than 50 wt%; no greater than 40 wt%; no greater than 30 wt%; no greater than 20 wt%; or no greater than 10 wt% of the total weight of the exemplary oxygen carriers.

Exemplary oxygen carriers may comprise one or more dopants, which may provide active sites for adsorption of reactant gas molecules. In various implementations, the one or more dopants and promoters may provide additional oxygen vacancies in the lattice of exemplary oxygen carriers, thereby improving the rates of ionic diffusion and lowering the activation energy barrier for product formation.

In various implementations, the one or more promoters and dopants may comprise oxide, metallic, and other derivatives of elements including, but not limited to, Na, Li, K, Mg, Ca, Sr, Ba, Ce, La, Be, Ni, Co, Cu, Sc, Ti, V, Cr, Mn, Zn, Y, Zr, Nb, Mo, Tc, Ru, Rh, Pd, Ag, Cd, Lu, Hf, Ta, W, Re, Os, Ir, Pt, Au, or combinations thereof.

Exemplary oxygen carriers may comprise one or more inert materials. Exemplary inert materials may provide for heat transfer across reactors in exemplary systems. In various implementations, the one or more inert materials may comprise SiO₂, SiC, Al₂O₃, MgO, CaO, TiO₂, MgAl₂O₄, ZrO₂, Y stabilized ZrO₂, alumina-silicates, clay supports such as kaolin and bentonite, alumina-zirconia-silica, and combinations thereof.

### 2. Physical Properties

Exemplary oxygen carriers have sufficient strength to withstand the transport between reactors. Various physical properties of exemplary oxygen carriers, such as crushing mechanical strength, may be determined using methods disclosed in “Chemically and physically robust, commercially-viable iron-based composite oxygen carriers sustainable over 3000 redox cycles at high temperatures for chemical looping applications,” Chung et. al, Energy Environ. Sci., 2017,10, 2318-2323, incorporated herein by reference in its entirety.

In various implementations, exemplary oxygen carriers have a crushing mechanical strength between 1 MPa 200 MPa; 5 MPa to 200 MPa; 10 MPa to 200 MPa; 15 MPa to 200 MPa; 20 MPa to 200 MPa; 25 MPa to 200 MPa; 30 MPa to 200 MPa; 40 MPa to 200 MPa; 50 MPa to 200 MPa; 60 MPa to 200 MPa; 70 MPa to 200 MPa; 80 MPa; to 200 MPa; 90 MPa to 200 MPa; 100 MPa to 200 MPa; 120 MPa; to 200 MPa; 140 MPa to 200 MPa; or 150 MPa to 200 MPa. In various implementations, exemplary oxygen carriers have a crushing mechanical strength of no less than 1 MPa; no less than 5 MPa; no less than 15 MPa; no less than 25 MPa; no less than 35 MPa; no less than 45 MPa; no less than 75 MPa; no less than 95 MPa; no less than 125 MPa; no less than 155 MPa; no less than 175 MPa; or no less than 195 MPa. In various implementations, exemplary oxygen carriers have a crushing mechanical strength of no greater than 200 MPa; no greater than 180 MPa; no greater than 160 MPa; no greater than 140 MPa; no greater than 120 MPa; no greater than 100 MPa; no greater than 90 MPa; no greater than 80 MPa; no greater than 70 MPa; no greater than 60 MPa; no greater than 50 MPa; no greater than 40 MPa; no greater than 30 MPa; no greater than 20 MPa; no greater than 10 MPa; or no greater than 5 MPa.

In various implementations, exemplary oxygen carriers may have a particle size from 0.2 mm to 5 mm. As used herein, “particle size” may refer to a median particle size. As used herein, the size may refer to a longest dimension of the particle. In various implementations, exemplary oxygen carriers may have a particle size from 0.2 mm to 5 mm; 0.5 mm to 5 mm; 0.8 mm to 5 mm; 1 mm to 5 mm; 1 mm to 4.5 mm; 1.2 mm to 4.5 mm; 1.5 mm to 4.5 mm; 1.5 mm to 4 mm; 1.8 mm to 4 mm; 2 mm to 4 mm; 2 mm to 3.5 mm; 2.5 mm to 3.5 mm; or about 3 mm. In various implementations, exemplary oxygen carriers may have a particle size of no less than no less than 0.2 mm; no less than 0.3 mm; no less than 0.5 mm; no less than 0.7 mm; no less than 0.9 mm; no less than 1.1 mm; no less than 1.3 mm; no less than 1.5 mm; no less than 1.7 mm; no less than 1.9 mm; no less than 2.1 mm; no less than 2.3 mm; no less than 2.5 mm; no less than 2.7 mm; no less than 2.9 mm; no less than 3.1 mm; no less than 3.3 mm; no less than 3.7 mm; no less than 3.9 mm; no less than 4.1 mm; no less than 4.3 mm; no less than 4.5 mm; no less than 4.7 mm; or no less than 4.9 mm. In various implementations, exemplary oxygen carries may have a particle size of no greater than 5 mm; no greater than 4.8 mm; no greater than 4.6 mm; no greater than 4.4 mm; no greater than 4.2 mm; no greater than 4 mm; no greater than 3.8 mm; no greater than 3.6 mm; no greater than 3.4 mm; no greater than 3.2 mm; no greater than 3 mm; no greater than 2.8 mm; no greater than 2.6 mm; no greater than 2.4 mm; no greater than 2.2 mm; no greater than 2 mm; no greater than 1.8 mm; no greater than 1.6 mm; no greater than 1.4 mm; no greater than 1.2 mm; no greater than 1 mm; no greater than 0.8 mm; no greater than 0.6 mm; no greater than 0.4 mm; no greater than 0.3 mm.

In various implementations, exemplary oxygen carriers may have a particle density from 1000 kg/m³ to 5000 kg/m³. In various implementations, exemplary oxygen carriers may have a particle density from 1000 kg/m³ to 4900 kg/m³; 1000 kg/m³ to 4800 kg/m³; 1000 kg/m³ to 4700 kg/m³; 1000 kg/m³ to 4600 kg/m³; 1000 kg/m³ to 4500 kg/m³; 1100 kg/m³ to 4500 kg/m³; 1200 kg/m³ to 4500 kg/m³; 1300 kg/m³ to 4500 kg/m³; 1400 kg/m³ to 4500 kg/m³; 1500 kg/m³ to 4500 kg/m³; 1600 kg/m³ to 4500 kg/m³; 1700 kg/m³ to 4500 kg/m³; 1800 kg/m³ to 4500 kg/m³; 1900 kg/m³ to 4500 kg/m³; 2000 kg/m³ to 4500 kg/m³; 2000 kg/m³ to 4000 kg/m³; 2500 kg/m³ to 4000 kg/m³; 2500 kg/m³ to 3500 kg/m³; or about 3000 kg/m³. In various implementations, exemplary oxygen carriers may have a particle density of no less than 1000 kg/m³; no less than 1200 kg/m³; no less than 1400 kg/m³; no less than 1600 kg/m³; no less than 1800 kg/m³; no less than 2000 kg/m³; no less than 2200 kg/m³; no less than 2400 kg/m³; no less than 2600 kg/m³; no less than 2800 kg/m³; no less than 3000 kg/m³; no less than 3200 kg/m³; no less than 3400 kg/m³; no less than 3600 kg/m³; no less than 3800 kg/m³; no less than 4000 kg/m³; no less than 4200 kg/m³; no less than 4400 kg/m³; no less than 4600 kg/m³; or no less than 4800 kg/m³. In various implementations, exemplary oxygen carriers may have a particle density of no greater than 5000 kg/m³; no greater than 4900 kg/m³; no greater than 4700 kg/m³; no greater than 4500 kg/m³; no greater than 4300 kg/m³; no greater than 4100 kg/m³; no greater than 3900 kg/m³; no greater than 3700 kg/m³; no greater than 3500 kg/m³; no greater than 3300 kg/m³; no greater than 3100 kg/m³; no greater than 2900 kg/m³; no greater than 2700 kg/m³; no greater than 2500 kg/m³; no greater than 2300 kg/m³; no greater than 2100 kg/m³; no greater than 1900 kg/m³; no greater than 1700 kg/m³; no greater than 1500 kg/m³; or no greater than 1300 kg/m3.

### C. Exemplary Oxygen-Providing Materials

Generally, exemplary oxygen-providing materials may be used for the oxidation of reduced oxygen carriers.

Exemplary oxygen-providing materials may comprise compounds that include one or more oxygen atoms. In various implementations, exemplary oxygen-providing may comprise steam (H₂O), air, oxygen (O₂), carbon dioxide (CO₂), and combinations thereof.

### D. Exemplary Waste Gas

Generally, exemplary waste gases may be used as a source of carbon and hydrogen for sustainable syngas generation. Exemplary waste gases may react with oxygen carriers, thereby generating carbon dioxide (CO₂) and/or steam (H₂O).

Exemplary waste gases may comprise waste gases and/or tail gases from chemical, petrochemical, refining, mining, metallurgical, ceramic, mineral, energy, bio-allied, agricultural, or related environment, municipal solid waste, animal wastes, and biomass.

### E. Exemplary Oxidation Products

Generally, exemplary oxidation products are the products of an exemplary first reactor, which may be configured as a moving bed reducer reactor.

In various implementations, exemplary oxidation products may comprise completely oxidized products, partially oxidized products, or upgraded syngas. In various implementations, partial oxidation products may comprise syngas (e.g., hydrogen gas (H₂) and carbon monoxide (CO)). In various implementations, complete oxidation products may comprise carbon dioxide (CO₂) and steam (H₂O). In various implementations, upgraded syngas comprises hydrogen gas (H₂) and carbon monoxide (CO) and is substantially free of tar. Substantially free of tar, as used herein, means no greater than 50 g/Nm³; no greater than 45 g/Nm³; no greater than 40 g/Nm³; no greater than 30 g/Nm³; no greater than 25 g/Nm³; no greater than 10 g/Nm³; no greater than 5 g/Nm³; no greater than 1 g/Nm³; no more than 0.5 g/Nm³, or no more than 0.05 g/Nm³.

### III. Exemplary Systems

Various exemplary systems for processing carbonaceous feedstock are described below. The various exemplary systems disclosed and contemplated herein may be scaled without reducing the performance of the exemplary systems.

In various implementations, a carbonaceous feedstock is provided to the exemplary systems such that there is sufficient mixing within an exemplary first reactor to prevent large agglomerations from forming. Exemplary systems may prevent large agglomerations from forming by employing multiple injection ports along the circumference of exemplary first reactors, and/or adding baffles near the injection ports.

In various implementations, exemplary carbonaceous feedstocks may include large, irregular shaped feeds. In various implementations, the inlets of exemplary systems may have various size to accommodate large, irregular shaped carbonaceous feedstocks.

Exemplary systems may include a moving bed reducer reactor, which may be configured for co-current or counter-current flow, referring to the relative flow of carbonaceous feedstock and exemplary oxygen carriers.

Exemplary systems may partially or completely oxidize the carbonaceous feedstock using the lattice oxygen from the exemplary oxygen carriers. The oxygen carriers exit the moving bed reducer reactor and flow into a combustor reactor, which may operate as a fluidized bed reactor or a moving bed reactor. The re-oxidation of the oxygen carriers is exothermic, and therefore the heat generated in the combustor may provide heat to the moving bed reducer reactor in a chemical loop of the exemplary systems. Exemplary systems may be arranged in various operations with a combination of moving bed and/or fluidized bed reactor configurations.

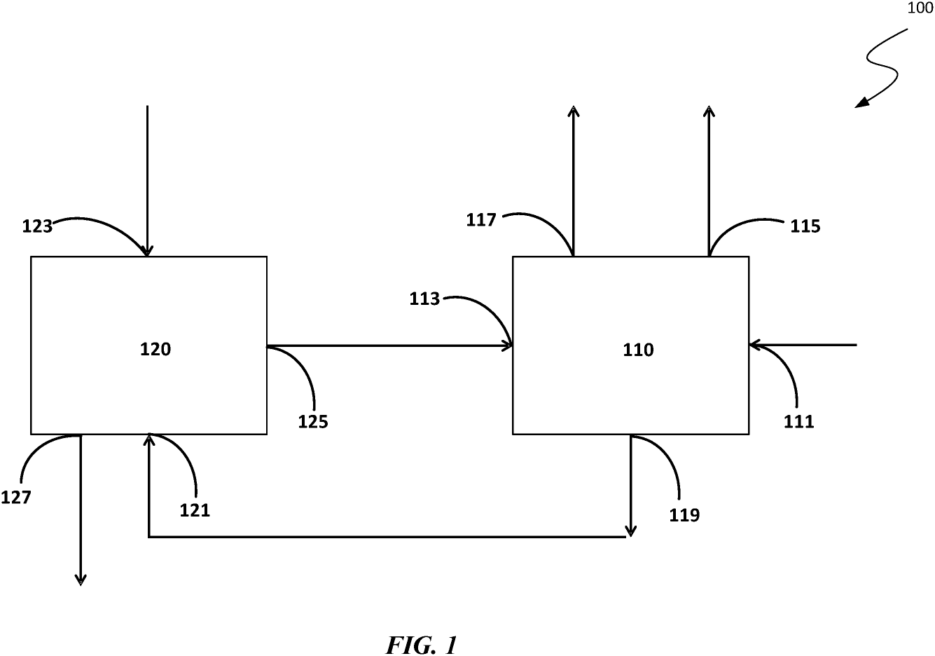

FIG. 1 shows an exemplary system 100 for processing carbonaceous feedstock. System 100 comprises exemplary reactor system 110 and chemical process 120, which are in fluid communication with each other.

Exemplary reactor system 110 includes carbonaceous feedstock inlet 111 and waste gas inlet 113 which is in fluid communication with chemical process 120. Exemplary system 110 further includes carbon dioxide (CO₂) outlet 115 and hydrogen gas (H₂) outlet 117. Exemplary system 110 further includes oxidation product outlet 119 which is in fluid communication with chemical process 120.

Chemical process 120 includes oxidation product inlet 121 which is in fluid communication with the exemplary reactor system 110. Chemical process 120 includes feedstock inlet 123. Chemical process 120 includes waste gas outlet 125 which is in fluid communication with exemplary reactor system 110. Chemical process 120 includes product outlet 127.

As shown, a feedstock is provided to the carbonaceous feedstock inlet 111 of exemplary reactor system 110, where the feedstock comprises carbonaceous feedstock as described above.

Exemplary reactor system 110 may receive a waste gas stream from chemical process 120 and recover additional energy from the waste gas stream. Exemplary reactor system 110 may generate a carbon dioxide stream (CO₂), thereby avoiding the requirement of an Acid Gas Remover (AGR) unit for carbon dioxide (CO₂) removal from exemplary reactor system 110.

Exemplary reactor system 110 may include internal and external heat transfer mechanisms for supplying and/or extracting heat. In various implementations, internal heat transfer examples include jacketing the walls of exemplary fixed bed reactor(s) with a heat transfer media and/or through an internal heat transfer coil, where the heat transfer media passes through the coil and performs heat transfer with the reactor(s) contents. In various implementations, external heat transfer may occur by heat transfer across the inlets and/or outlets by utilizing a heat exchanger. The heat exchanger may be used to perform heat integration across exemplary system 110 or throughout exemplary system 100.

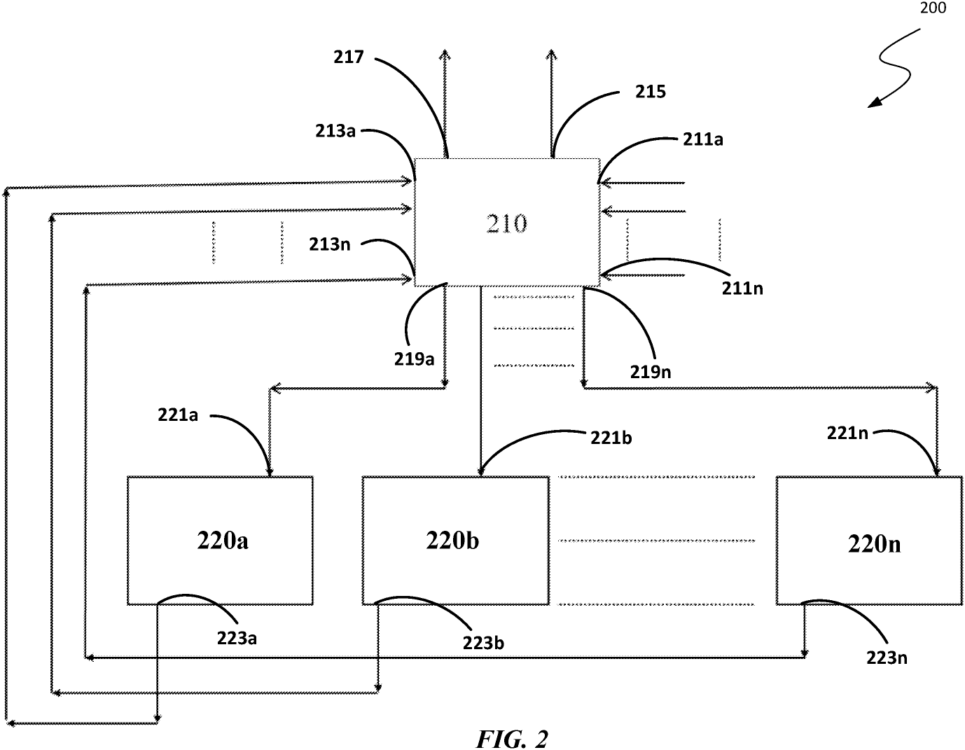

FIG. 2 shows an exemplary system 200 for processing carbonaceous feedstock. Unless otherwise indicated, and for the sake of brevity, components in FIG. 2 have the same or similar arrangement and operation as those similarly numbered in system 100 shown in FIG. 1. System 200 also comprises one or more chemical processes 220a . . . 220n.

As shown, exemplary reactor system 210 may include one or more carbonaceous feedstock inlets 211a. . . 211n in fluid communication with one or more carbonaceous feed streams. Exemplary reactor system 210 may include one or more one or more waste gas inlets 213a . . . 213n in fluid communication with the one or more chemical processes 220a . . . 220n. Exemplary reactor system may include one or more oxidation product outlets 219a . . . 219n in fluid communication with the one or more chemical processes 220a . . . 220n.

As shown, reactor system 210 generates and discharges carbon dioxide (CO₂) via outlet 215. As shown, reactor system 210 generates and discharges hydrogen gas (H₂) via outlet 217.

As shown, one or more chemical processes 220a . . . 220n may include one or more oxidation product inlets 221a . . . 221n in fluid communication with exemplary reactor system 210. One or more chemical processes 220a . . . 220n may include one or more waste gas outlets 223a . . . 223n in fluid communication with exemplary reactor system 210.

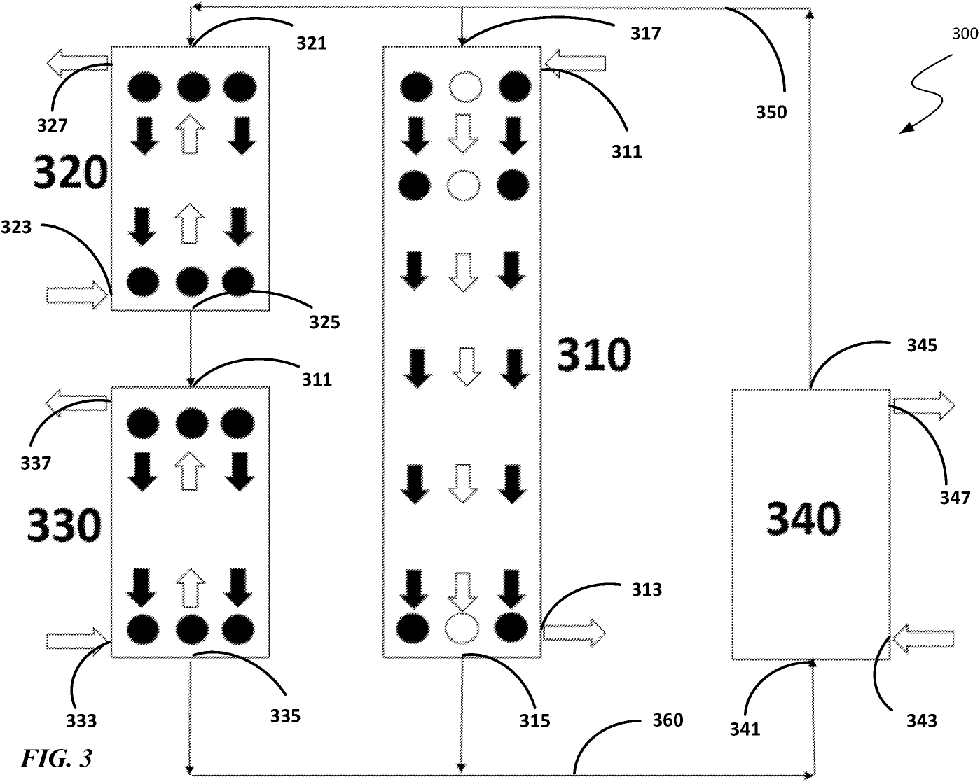

FIG. 3 shows an exemplary system 300 for processing carbonaceous feedstock. As shown in FIGS. 3-15, open arrows schematically represent gas movement direction within reactors, and closed arrows schematically represent solids movement direction within reactors.

System 300 comprises co-current first reactor 310 in fluid communication with an oxidized oxygen carrier stream 350 and reduced oxygen carrier stream 360. System 300 further comprises counter-current second reactor 320 and counter-current third reactor 330, which are in fluid communication and in series with each other. Counter-current second reactor 320 is in fluid communication with the oxidized oxygen carrier stream 350. Counter-current third reactor 330 is in fluid communication with the reduced oxygen carrier stream 360. Co-current first reactor 310 is arranged in parallel with the counter-current second reactor 320 and counter-current third reactor 330. System 300 further comprises a co-current fourth reactor 340 in fluid communication with the oxidized oxygen carrier stream 350 and the reduced oxygen carrier stream 360.

Referring to the systems shown in FIGS. 3-15, although shown schematically as first reactors and second reactors being in fluid communication with oxidized oxygen carrier streams, in some instances, first reactors and/or second reactors may be individually in fluid communication with an outlet of fourth reactors. Referring to the systems shown in FIGS. 3-15, although shown schematically in the figures as the oxygen carrier outlets mixing to form reduced oxygen carrier stream, in some instances, each reactor outlet providing reduced oxygen carriers may be individually in fluid communication with an inlet of fourth reactor.

Co-current first reactor 310 includes first inlet 311 and second inlet 317, such that co-current first reactor 310 is arranged to operate in co-current flow fashion. Co-current first reactor 310 further includes first outlet 313 in fluid communication with one or more chemical processes and second outlet 315 which is in fluid communication with reduced oxygen carrier stream 360.

Counter-current second reactor 320 includes first inlet 321 and second inlet 323, such that counter-current second reactor 320 is arranged to operate in counter-current flow fashion. Counter-current second reactor 320 includes first outlet 325 which is in fluid communication with the counter-current third reactor 330. Counter-current second reactor 320 includes second outlet 327.

Counter-current third reactor 330 includes first inlet 331 and second inlet 333, such that counter-current third reactor 330 is arranged to operate in counter-current flow fashion. Counter-current third reaction 330 includes first outlet 335 which is in fluid communication with the reduced oxygen carrier stream 360. Counter-current third reaction 330 includes second outlet 337.

Co-current fourth reactor 340 includes first inlet 341 and second inlet 343, such that co-current fourth reactor 340 is arranged to operate in co-current flow fashion. Co-current fourth reactor 340 includes first outlet 345 which is in fluid communication with the oxidized oxygen carrier stream 350. Co-current fourth reactor 340 includes second outlet 347.

As shown, a feedstock is provided to the first inlet 311 of co-current first reactor 310, where the feedstock comprises carbonaceous feedstock. Typically, co-current first reactor 310 is configured as a moving bed reducer reactor.

In various implementations, the feedstock is catalytically decomposed using oxygen carriers in co-current first reactor 310 to form syngas. The oxygen carriers in co-current first reactor 310 crack higher hydrocarbons into syngas, carbon dioxide (CO₂), and/or steam (H₂O). In various implementations, the reaction of cracking higher hydrocarbons into syngas, carbon dioxide (CO₂), and/or steam (H₂O) reduces the formation of tars. Tars may cause issues in downstream processing equipment such as fouling and damage to sensitive operation instrumentation, or poisoning of the oxygen carriers in downstream operations.

Syngas is provided from the first outlet 313 of co-current first reactor 310 to one or more chemical processes, which are in fluid communication with the first outlet 313.

The oxygen carriers undergo reduction by the loss of lattice oxygen during the oxidation of the feedstock in co-current first reactor 310. As shown, the second outlet 315 of co-current first reactor 310 is in fluid communication with the reduced oxygen carrier steam 360, where the reduced oxygen carriers are transported from the second outlet 315 to the first inlet 341 of co-current fourth reactor 340.

As shown, the oxidized oxygen carriers are provided to the first inlet 321 of counter-current second reactor 320. Waste gases from one or more downstream processes (such as one or more chemical processes) are provided to the second inlet 323 of counter-current second reactor 320. Typically, counter-current second reactor 320 is configured as a moving bed reducer reactor.

In various implementations, the waste gases undergo full oxidation using the oxidized oxygen carriers in counter-current second reactor 320 to form oxidation products (such as carbon dioxide (CO₂) and/or steam (H₂O)) and reduced oxygen carriers. As shown, the oxidation products are provided from the second outlet 327.

The oxygen carriers undergo reduction by the loss of lattice oxygen during the full oxidation of the waste gases in counter-current second reactor 320. As shown, the first outlet 325 of counter-current second reactor 320 is in fluid communication with the counter-current third reactor 330, where the reduced oxygen carriers are provided from the first outlet 325 to the first inlet 331 of counter-current third reactor 330.

As shown, the reduced oxygen carriers are provided to the first inlet 331 of counter-current third reactor 330. Oxygen-source materials are provided to the second inlet 333 of counter-current third reactor 330. Typically, counter-current third reactor 330 is configured as a moving bed reducer reactor.

In various implementations, the oxygen-source materials undergo partial oxidation using the reduced oxygen carriers in counter-current third reactor 330 to form hydrogen gas (H₂) and partially reduced oxygen carriers. As shown, the hydrogen gas (H₂) is provided from the second outlet 337.

The oxygen carriers undergo partial re-oxidation by receiving lattice oxygen from the oxygen-source materials in counter-current third reactor 330. As shown, the first outlet 335 of counter-current third reactor 330 is in fluid communication with the reduced oxygen carrier stream 360, where the partially reduced oxygen carriers are provided from the first outlet 335 to the first inlet 341 of co-current fourth reactor 340.

As shown, the first inlet 341 of co-current fourth reactor 340 is in fluid communication with the reduced oxygen carrier stream 360. Reduced oxygen carriers and partially reduced oxygen carriers are provided to the first inlet 341 of co-current fourth reactor 340. Co-current fourth reactor 340 may be configured as a fluidized bed reactor.

As shown, oxidizing material is provided to the second inlet 343 of co-current fourth reactor 340. The oxidizing material regenerates the reduced oxygen carriers in co-current fourth reactor 340.

As shown, reduced products are provided from the second outlet 347 of co-current fourth reactor 340.

As shown, the first outlet 345 of co-current fourth reactor 340 is in fluid communication with the oxidized oxygen carrier stream 350. The oxidized oxygen carriers, after undergoing regeneration, are provided from the first outlet 345 to the oxidized oxygen carrier stream 350 and are transported to the second inlet 317 and first inlet 321.

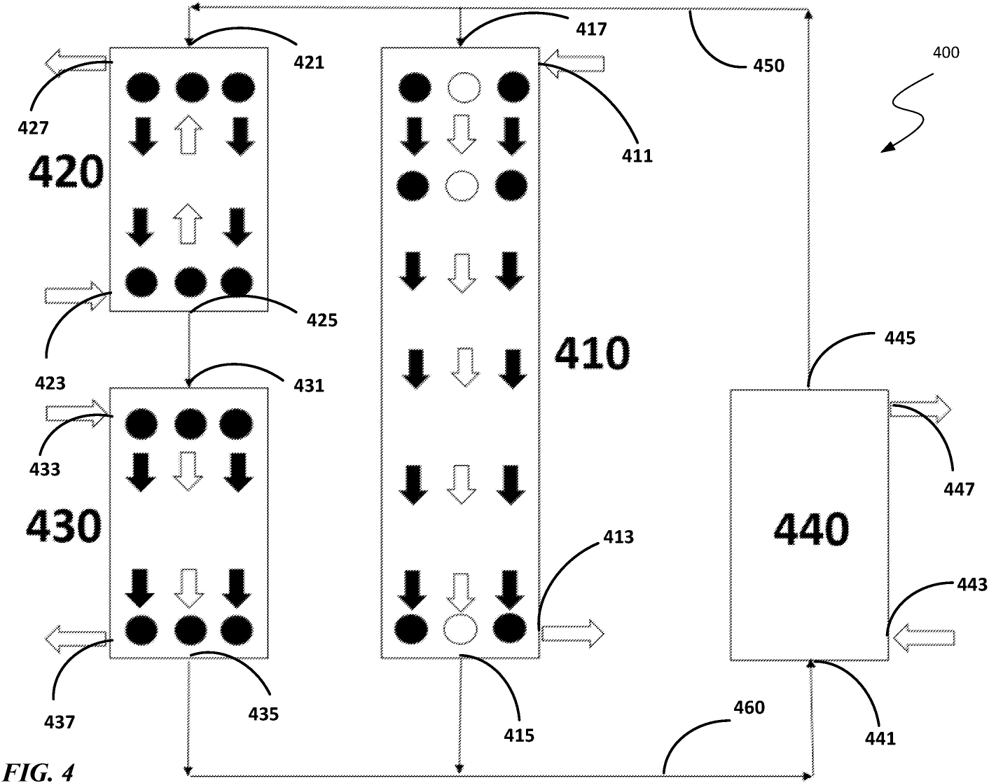

FIG. 4 shows exemplary system 400 for processing carbonaceous feedstock. Unless otherwise indicated, and for the sake of brevity, components in FIG. 4 have the same or similar arrangement and operation as those similarly numbered in system 300 shown in FIG. 3. System 400 comprises co-current third reactor 430, in contrast to counter-current third reactor 330. Co-current third reactor 430 includes first inlet 431 and second inlet 433 such that co-current third reactor 430 is arranged to operate in co-current flow fashion.

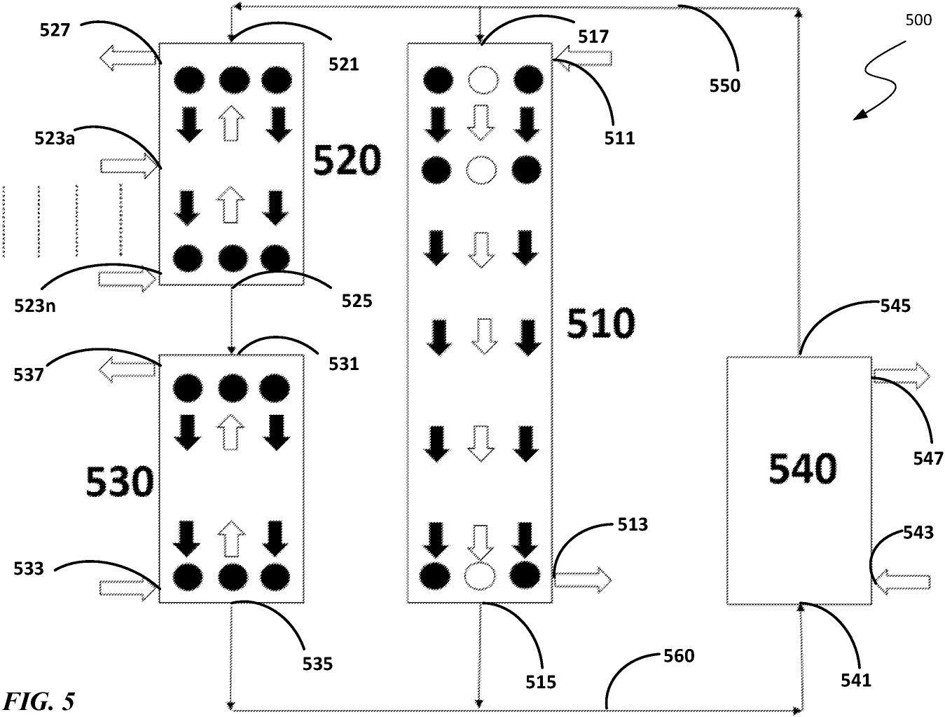

FIG. 5 shows an exemplary system 500 for processing carbonaceous feedstock. Unless otherwise indicated, and for the sake of brevity, components in FIG. 5 have the same or similar arrangement and operation as those similarly numbered in system 300 shown in FIG. 3. System 500 also comprises a plurality of waste gas streams provided to a plurality of second inlets 523 ... 523n. The plurality of second inlets 523 . . . 523n are arranged at different heights of reactor 520. In some instances, the plurality of second inlets 523 . . . 523n are arranged according to the reducing potential of the incoming stream, with the highest reducing potential being at the bottommost location and the lowest reducing potential being at the topmost location.

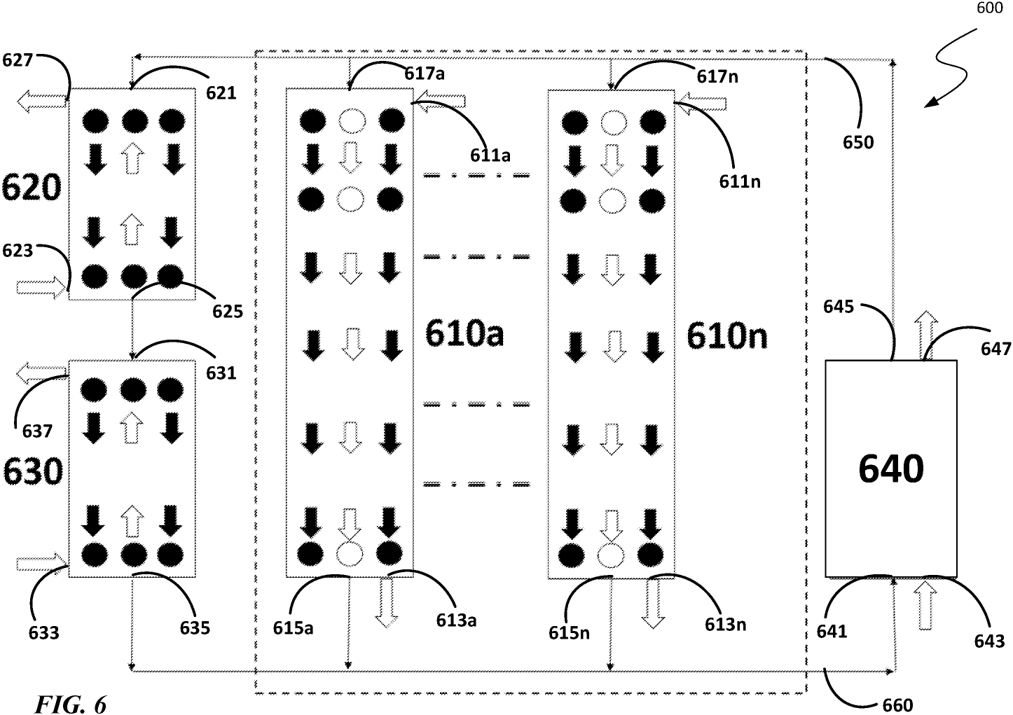

FIG. 6 shows an exemplary system 600 for processing carbonaceous feedstock. Unless otherwise indicated, and for the sake of brevity, components in FIG. 6 have the same or similar arrangement and operation as those similarly numbers in system 300 shown in FIG. 3. System 600 comprises a plurality of co-current first reactors 610 in fluid communication with the oxidized oxygen carrier stream 650 and the reduced oxygen carrier stream 660.

As shown, a carbonaceous feedstock is provided to the plurality of first inlets 611a . . . 611n of the plurality of first reactors 610a . . . 610n, where the feedstock comprises carbonaceous feedstock. In various implementations, the plurality of co-current first reactors 610a . . . 610n may be configured as moving bed reactors.

As shown, the syngas is provided from the plurality of first outlets 613a . . . 613n of the plurality of co-current first reactors 610a . . . 610n, where the plurality of first outlets 613a. . . 613n are in fluid communication with one or more chemical processes.

As shown, the plurality of second outlets 615a . . . 615n of the plurality of co-current first reactors 610a . . . 610n are in fluid communication with the reduced oxygen carrier stream 660, where the reduced oxygen carriers are provided from the plurality of second outlets 615a .. . 615n to the first inlet 641 of the co-current fourth reactor 640.

As shown, the first outlet 645 is in fluid communication with the oxidized oxygen carrier stream 650, and the oxidized oxygen carrier stream 650 is in fluid communication with the plurality of second inlets 617a . . . 617n of the plurality of co-current first reactors 610a . . . 617n. As shown, the oxidized oxygen carriers, after undergoing regeneration, are provided from the first outlet 645 to the oxidized oxygen carrier stream 650, which transports the oxidized oxygen carriers to the plurality of second inlets 617a . . . 617n.

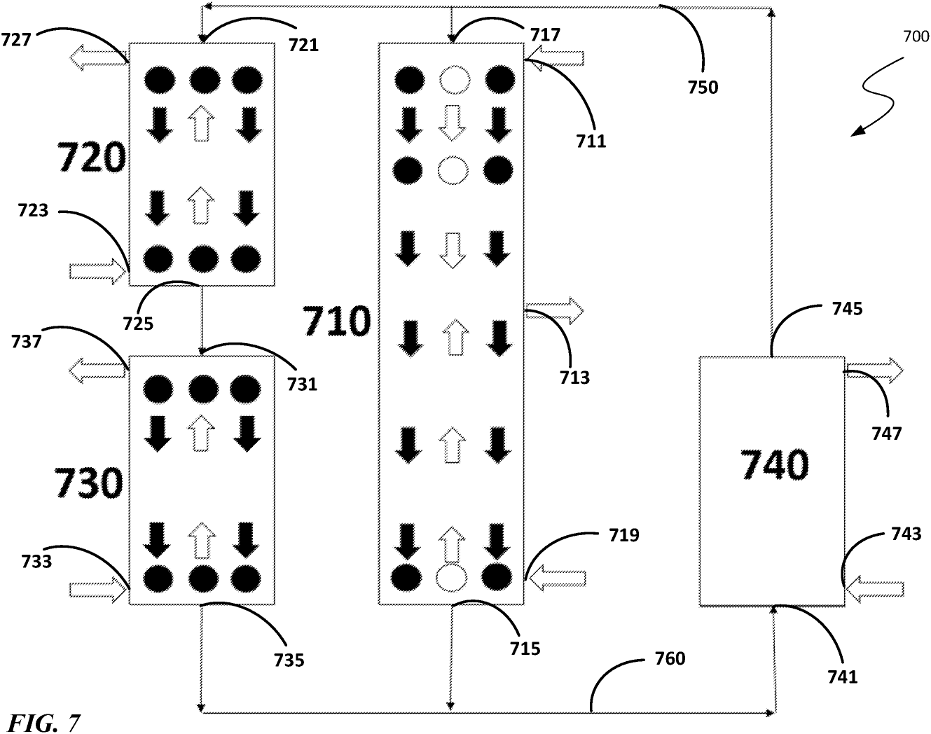

FIG. 7 shows an exemplary system 700 for processing carbonaceous feedstock. Unless otherwise indicated, and for the sake of brevity, components in FIG. 7 have the same or similar arrangement and operation as those similarly numbered in system 300 shown in FIG. 3. System 700 comprises a cross-current first reactor 710, in contrast to co-current first reactor 310. Cross-current first reactor 710 includes first inlet 711 in fluid communication with the oxidized oxygen carrier stream 750.

Cross-current first reactor 710 includes first inlet 711, second inlet 717, and third inlet 719, such that cross-current first reactor 710 is arranged to operate in cross-current flow fashion.

As schematically shown, third inlet 719 is positioned near a bottom portion of the cross-current first reactor 710. First outlet 713 is positioned near a middle portion of cross-current first reactor 710.

As shown, cross-current first reactor 710 includes first outlet 713 which is in fluid communication with one or more chemical processes. Cross-current first reactor 710 further includes second outlet 715 which is in fluid communication with the reduced oxygen carrier stream 760.

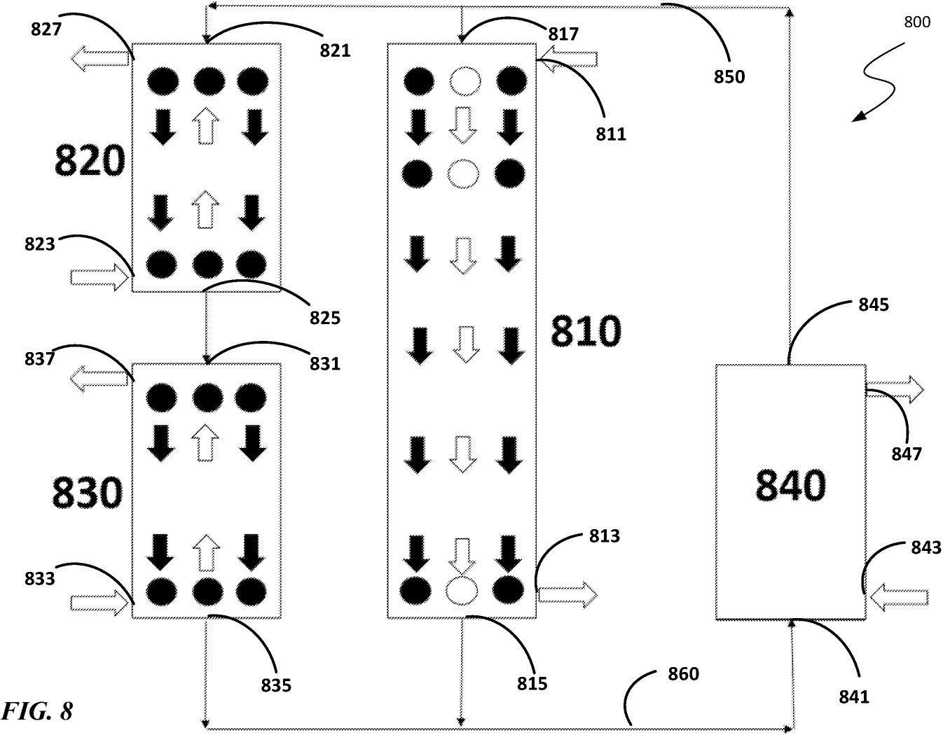

FIG. 8 shows an exemplary system 800 for processing carbonaceous feedstock. Unless otherwise indicated, and for the sake of brevity, components in FIG. 8 have the same or similar arrangement and operation as those similarly numbered in system 300 in FIG. 3.

In system 800, counter-current third reactor 830 receiving oxygen-source materials at the second inlet 833. The oxygen-source materials may comprise carbon dioxide (CO₂) and/or steam (H₂O).

In various implementations, the reduced oxygen carriers undergo re-oxidation by the oxygen-source materials provided to the second inlet 833. The oxygen-source materials undergo splitting into partial oxidation products, where carbon dioxide (CO₂) splits into carbon monoxide (CO) and steam (H₂O) splits into hydrogen gas (H₂). Accordingly, a variable syngas composition can be achieved by varying the ratio of steam (H₂O) and carbon dioxide (CO₂) at second inlet 833.

As shown, the partial oxidation products (i.e., carbon monoxide (CO) and hydrogen gas (H₂)) are provided to the second outlet 837 of counter-current third reactor 830.

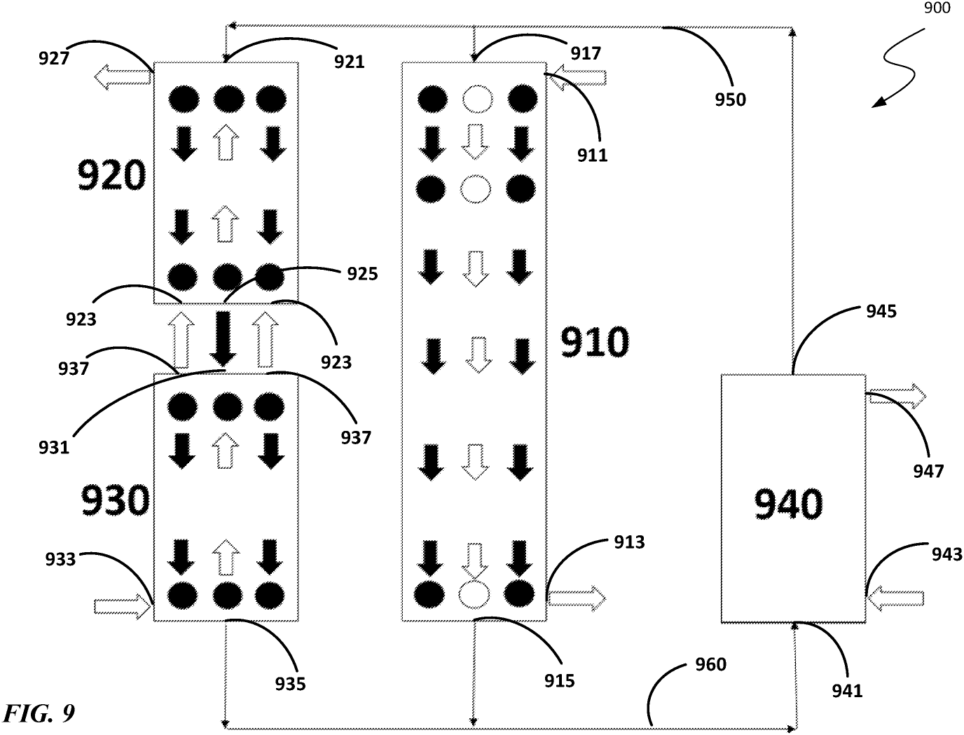

FIG. 9 shows an exemplary system 900 for processing carbonaceous feedstock. Unless otherwise indicated, and for the sake of brevity, components in FIG. 9 have the same or similar arrangement and operation as those similarly numbered in system 300 shown in FIG. 3.

As shown, the second inlet 923 of counter-current second reactor 920 is in fluid communication with the second outlet 937 of counter-current third reactor 930. In various implementations, the second inlet 923 of counter-current second reactor 920 is configured to receive gases, typically oxidized waste gases, from the second outlet 937 of counter-current third reactor 930.

As shown, the first inlet 931 of counter-current third reactor is in fluid communication with the first outlet 925 of counter-current second reactor 920. The reduced oxygen carriers are provided to the first inlet 931 of counter-current third reactor from the first outlet 925 of counter-current second reactor 920.

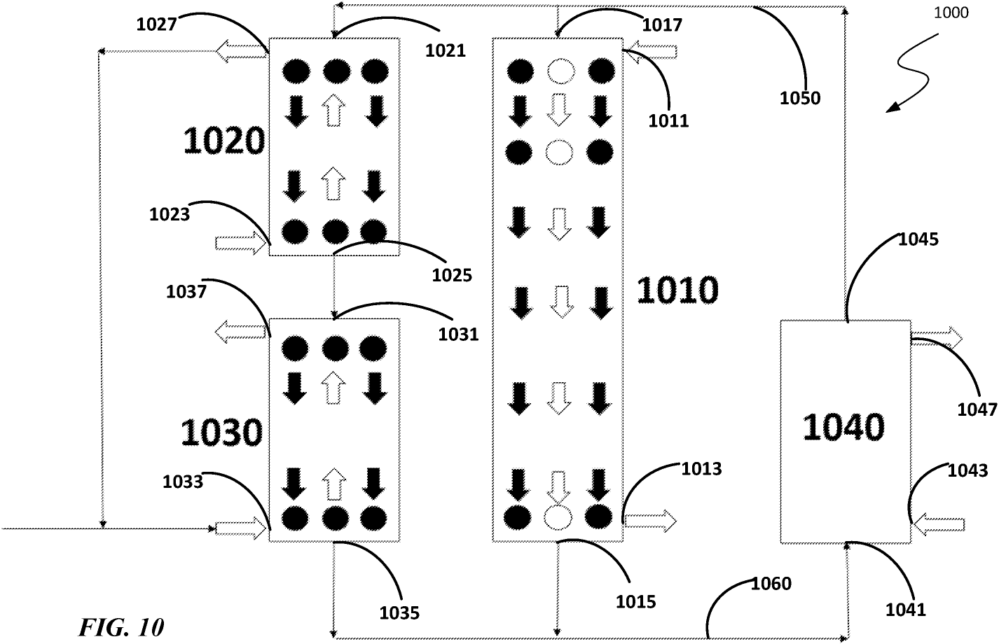

FIG. 10 shows an exemplary system 1000 for processing carbonaceous feedstock. Unless otherwise indicated, and for the sake of brevity, components in FIG. 10 have the same or similar arrangement and operation as those similarly numbers in system 300 shown in FIG. 3. In system 1000, the second outlet 1027 of counter-current second reactor 1020 is in fluid communication with the second inlet 1033 of counter-current third reactor 1030.

As shown, the second outlet 1027 of counter-current second reactor 1020 provides the oxidation products (i.e., carbon dioxide (CO₂) and hydrogen gas (H₂O)) to the second inlet 1033 of counter-current third reactor 1030. In some implementations, a fraction of the oxidation products generated in counter-current second reactor 1020 are provided to the second inlet 1033 of counter-current third reactor 1030. In some implementations, all of the oxidation products generated in counter-current second reactor 1020 are provided to the second inlet 1033 of counter-current third reactor 1030.

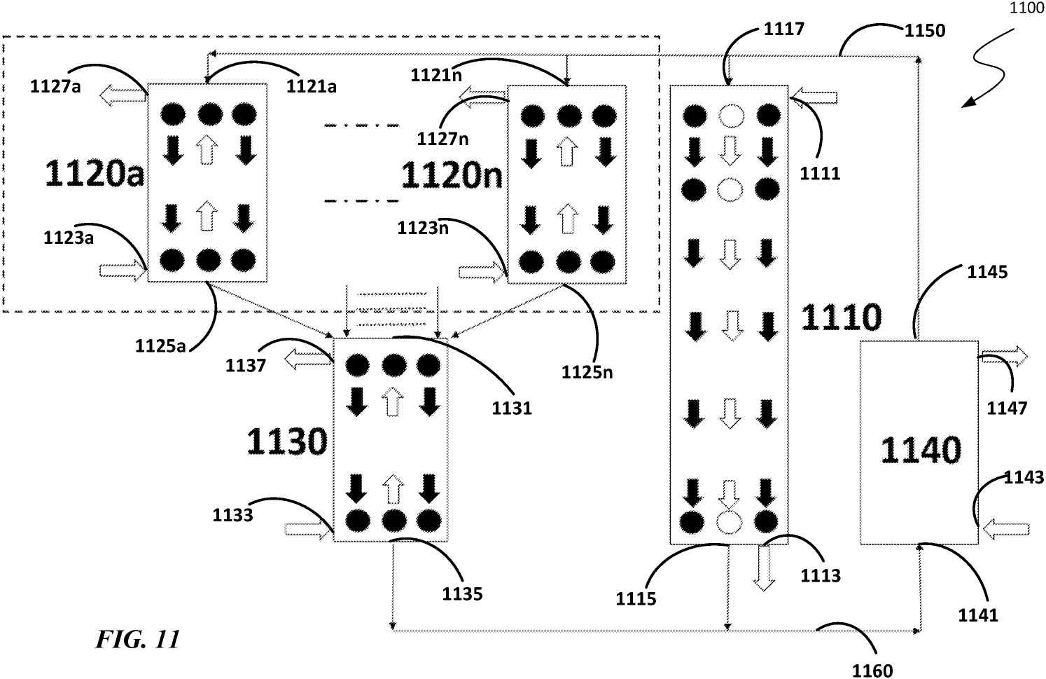

FIG. 11 shows an exemplary system 1100 for processing carbonaceous feedstock. Unless otherwise indicated, and for the sake of brevity, components in FIG. 11 have the same or similar arrangement and operation as those similarly numbered in system 300 shown in FIG. 3. System 1100 comprises a plurality of counter-current second reactors 1120a 1120n in fluid communication with counter-current third reactor 1130.

As shown, oxidized oxygen carriers are provided to the plurality of first inlets 1121a . .. 1121n of the plurality of counter-current second reactors 1120a 1120n. Waste gases from one or more downstream processes (i.e., one or more chemical processes) are provided to the one or more second inlets 1123a ... 1123n of the plurality of counter-current second reactors 1120a . .. 1120n. Typically, the plurality of counter-current second reactors 1120a . . . 1120n are configured as moving bed reducer reactors.

In various implementations, the waste gases undergo full oxidation using the oxidized oxygen carriers in the plurality of counter-current second reactors 1120a . . . 1120n to form oxidation products (i.e., carbon dioxide (CO₂) and/or steam (H₂O)) and reduced oxygen carriers. As shown, the oxidation products are provided from the plurality of second outlets 1127a . . . 1127n.

The oxygen carriers undergo reduction by the loss of lattice oxygen during the full oxidation of the waste gases in the plurality of counter-current second reactors 1120a ... 1120n. As shown, the plurality of first outlets 1125a . . . 1125n of the plurality of counter-current second reactors 1120a . . . 1120n are in fluid communication with counter-current third reactor 1130, where the reduced oxygen carriers are provided from the plurality of first outlets 1125a . . . 1125n to the first inlet 331 of counter-current third reactor 1130.

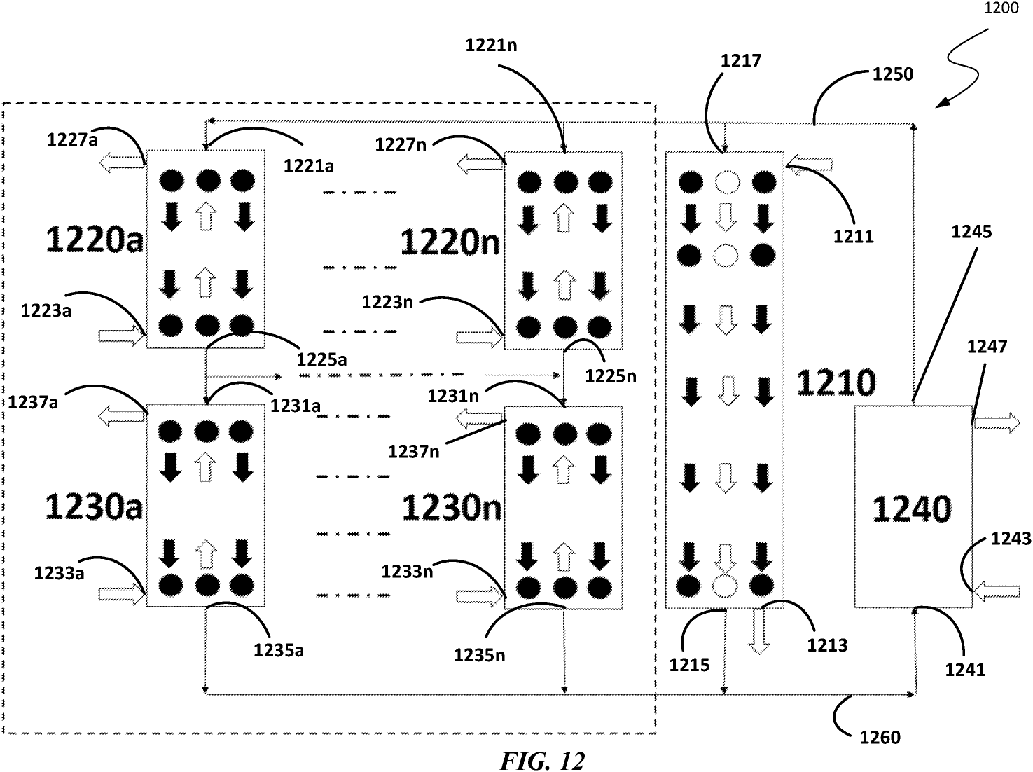

FIG. 12 shows an exemplary system 1200 for processing carbonaceous feedstock. Unless otherwise indicated, and for the sake of brevity, components in FIG. 12 have the same or similar arrangement and operation as those similarly numbered in system 1100 shown in FIG. 11. System 1200 comprises a plurality of counter-current third reactors 1230a . . . 1230n in fluid communication with the reduced oxygen carrier stream 1260.

As shown, the reduced oxygen carriers are provided to the plurality of first inlets 1231a ... 1231n of the plurality of counter-current third reactors 1230a . . . 1230n from the plurality of first outlets 1225a . . . 1225n of the plurality of counter-current second reactors 1220a . . . 1220n. Oxygen-source materials are provided to the plurality of second inlets 1233a .. . 1233n of the plurality of counter-current third reactors 1230a . . . 1230n. Typically, one or more counter-current third reactors 1230 are configured as a moving bed reducer reactor.

In various implementations, the oxygen-source materials undergo partial oxidation using the reduced oxygen carriers in the plurality of counter-current third reactors 1230a ... 1230n to form hydrogen gas (H₂) and partially reduced oxygen carriers. As shown, the hydrogen gas (H₂) is provided from the plurality of second outlets 1237a . . . 1237n.

The oxygen carriers undergo partial re-oxidation by receiving lattice oxygen during the partial re-oxidation from the oxygen-source materials in the plurality of counter-current third reactors 1230a . . . 1230n. As shown, the plurality of first outlets 1235a . . . 1235n of the plurality of counter-current third reactors 1230a . . . 1230n are in fluid communication with the reduced oxygen carrier stream 1260, where the partially reduced oxygen carriers are transported from the plurality of first outlets 1225a . . . 1225n to the first inlet 1241 of co-current fourth reactor 1240.

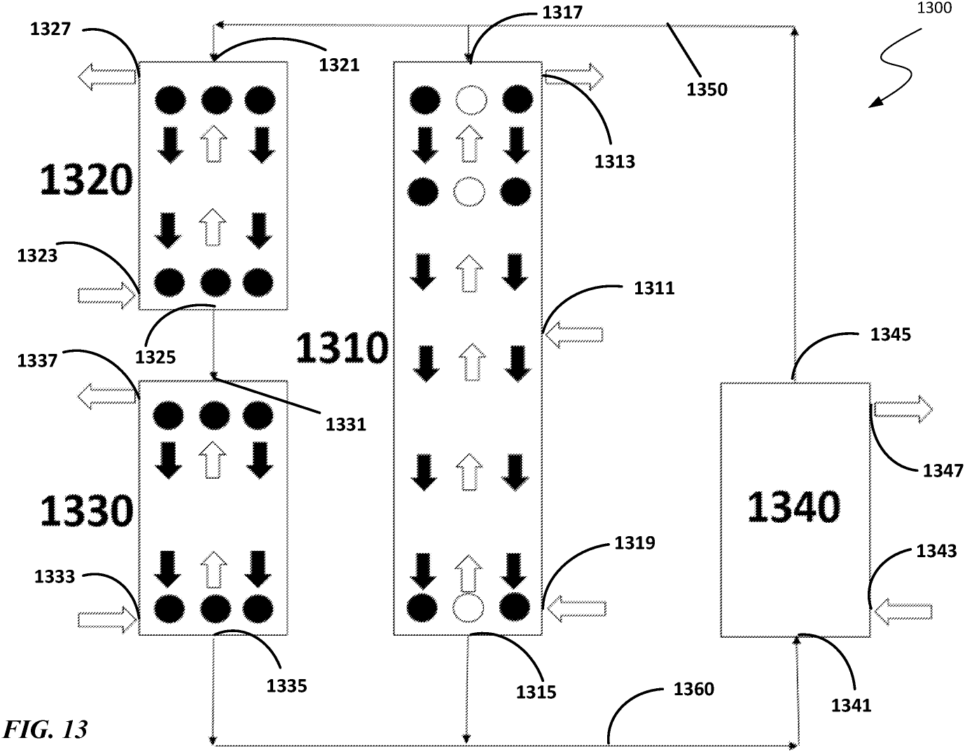

FIG. 13 shows an exemplary system 1300 for processing carbonaceous feedstock. Unless otherwise indicated, and for the sake of brevity, components in FIG. 13 have the same or similar arrangement and operation as those similarly numbered in system 300 shown in FIG. 3. System 1300 comprises a counter-current first reactor 1310. Counter-current first reactor 1310 includes first inlet 1311 in fluid communication with the oxidized oxygen carrier stream 1350.

Counter-current first reaction 1310 includes first inlet 1311, second inlet 1317, and third inlet 1319, such that counter-current first reactor 1310 is arranged to operate in counter-current flow fashion.

As shown, first inlet 1311 is positioned near a middle portion of counter-current first reactor 1310. Steam and/or carbon dioxide (CO₂) may be provided to first inlet 1311. Third inlet 1319 is positioned near a bottom portion of counter-current first reactor 1310.

As shown, first outlet 1313 is positioned near a top portion of counter-current first reactor 1310, and first outlet 1313 is in fluid communication with one or more chemical processes.

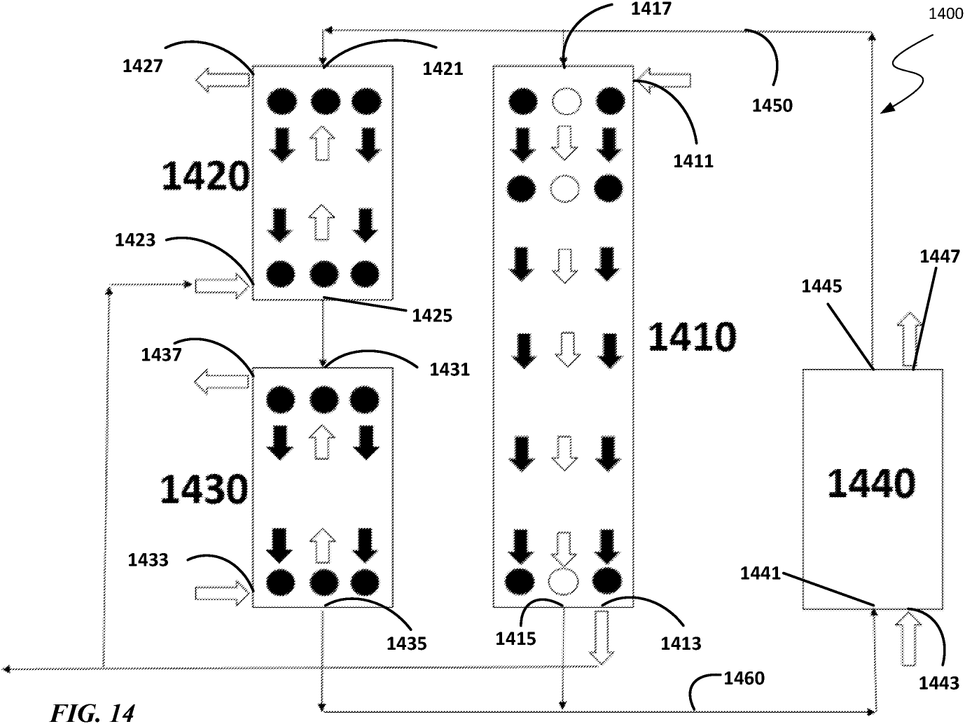

FIG. 14 shows an exemplary system 1400 for processing carbonaceous feedstock. Unless otherwise indicated, and for the sake of brevity, components in FIG. 14 have the same or similar arrangement and operation as those similar numbered in system 300 shown in FIG. 3. As shown, first outlet 1413 of co-current first reactor 1410 is in fluid communication with the second inlet 1423 of counter-current second reactor 1420 and in fluid communication with one or more chemical processes. As shown, syngas is provided from the first outlet 1413 of co-current first reactor 1410 to the second inlet 1423 of counter-current second reactor 1420 and one or more chemical processes.

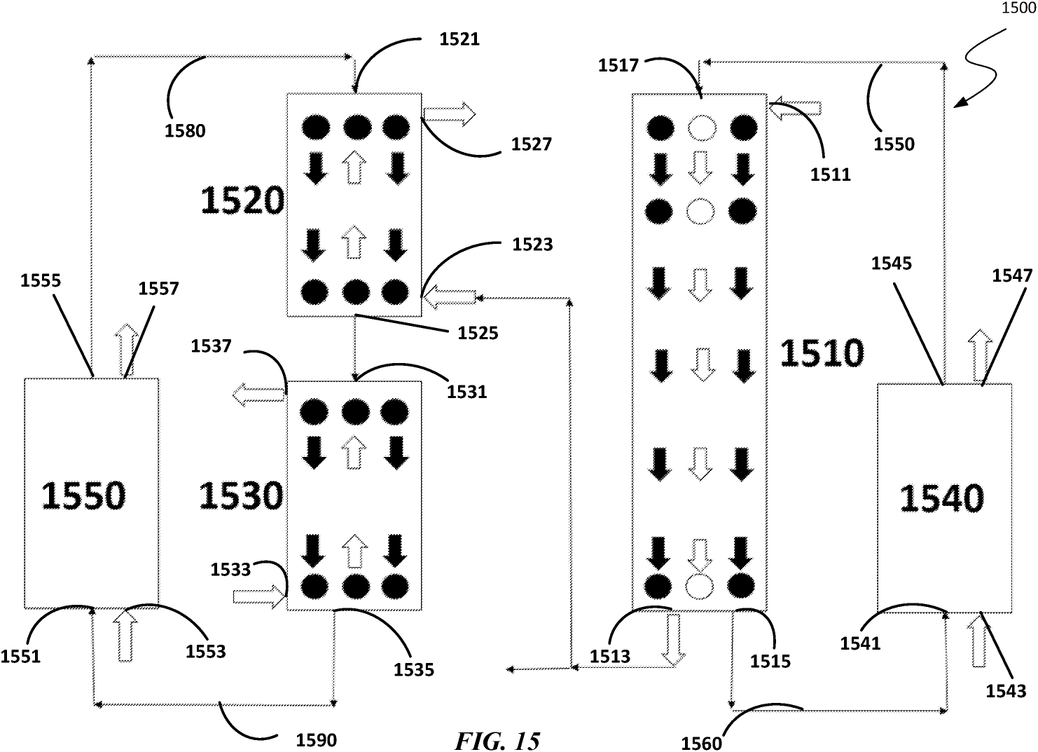

FIG. 15 shows an exemplary system 1500 for processing carbonaceous feedstock. Unless otherwise indicated, and for the sake of brevity, components in FIG. 15 have the same or similar arrangement and operation as those similar numbered in system 300 shown in FIG. 3.

System 1500 comprises a co-current fourth reactor 1540 in fluid communication with first reduced oxygen carrier stream 1560 and first oxidized oxygen carrier stream 1550. System 1500 further comprises a co-current fifth reactor 1570 in fluid communication with second reduced oxygen carrier stream 1590 and second oxidized oxygen carrier stream 1580.

As shown, the first outlet 1513 of co-current first reactor 1510 is in fluid communication with second inlet 1523 of counter-current second reactor 1520. The first outlet 1513 of co-current first reactor 1510 is in fluid communication with one or more chemical processes. Syngas is provided from the first outlet 1513 of co-current first reactor 1510 to the second inlet 1523 of counter-current second reactor 1520.

As shown, the second outlet 1515 of co-current first reactor 1510 is in fluid communication with the first reduced oxygen carrier stream 1560. The second outlet 1515 of co-current first reactor 1510 provides the first reduced oxygen carriers to the first reduced oxygen carrier stream 1560, which transports the first reduced oxygen carriers to a first inlet 1541 of co-current fourth reactor 1540.

First outlet 1545 of co-current fourth reactor 1540 provides the first oxidized oxygen carriers to the first oxidized oxygen carrier stream 1550, which transports the first oxidized oxygen carriers to the second inlet 1517 of co-current first reactor 1510.

As shown, the first outlet 1535 of counter-current third reactor 1530 is in fluid communication with the second reduced oxygen carrier stream 1590. The first outlet 1535 of counter-current third reactor 1530 provides the second reduced oxygen carriers to the second reduced oxygen carrier stream 1590, which transports the second reduced oxygen carriers to a first inlet 1571 of co-current fifth reactor 1570.

First outlet 1575 of co-current fifth reactor 1570 provides the second oxidized oxygen carriers to the second oxidized oxygen carrier stream 1580, which transports the second oxidized oxygen carriers to the first inlet 1521 of counter-current second reactor 1520.

As shown, the second outlet 1527 of counter-current second reactor 1520 provides oxidation products.

As shown, oxygen-source materials are provided to the second inlet 1533 of counter-current third reactor 1530. The second outlet 1537 of counter-current third reactor 1530 provides hydrogen gas (H₂).

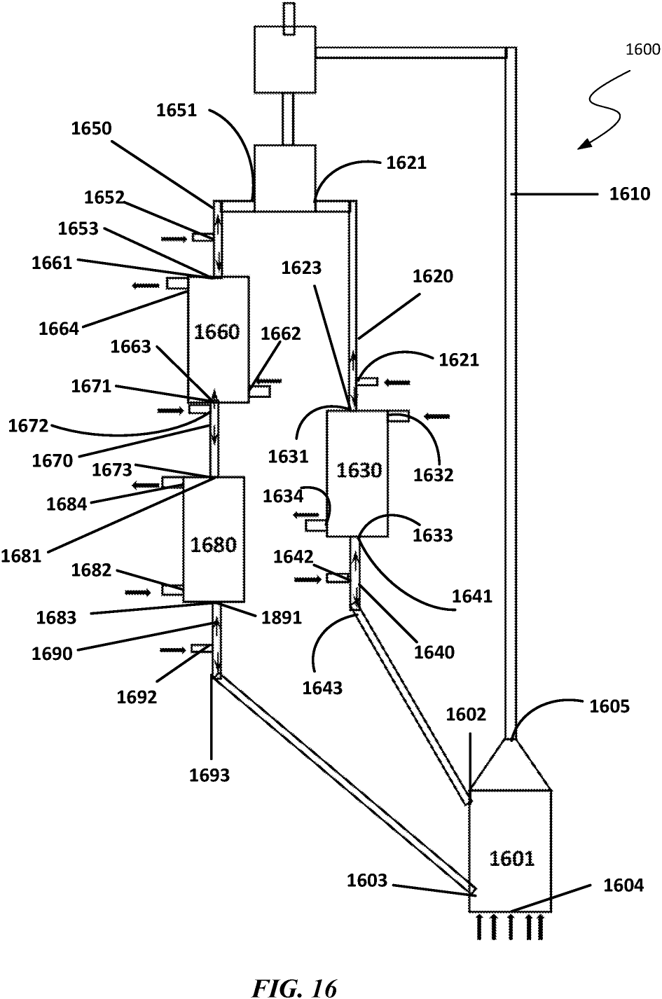

FIG. 16 shows an exemplary system 1600 for processing carbonaceous feedstocks. System 1600 comprises combustor 1601 in fluid communication with a riser 1610. Riser 1610 is in fluid communication with first gas-sealing device 1620. First gas-sealing device 1620 is in fluid communication with first reducer reactor 1630. First reducer reactor 1630 is in fluid communication with second gas-sealing device 1640. Second gas-sealing device 1640 is in fluid communication with combustor 1601. System 1600 further comprises riser 1610 is in fluid communication with third gas-sealing device 1650. Third gas-sealing device 1650 is in fluid communication with second reducer reactor 1660. Second reducer reactor 1660 is in fluid communication with fourth gas-sealing device 1670. Fourth gas-sealing device 1670 is in fluid communication with oxidizer reactor 1680. Oxidizer reactor is in fluid communication with fifth gas-sealing device 1690. Fifth gas-sealing device 1690 is in fluid communication with combustor 1601.

Combustor 1601 includes first inlet 1602, second inlet 1603, and third inlet 1604, such that combustor 1601 is arranged to operate in co-current flow fashion. Combustor 1601 further includes outlet 1605 in fluid communication with riser 1610.

Combustor 1601 may be configured as a fluidized bed. As shown, first reduced oxygen carriers are provided to first inlet 1602 of combustor 1601 from first reducer reactor 1630. Partially reduced oxygen carriers are provided to second inlet 1603 of combustor 1601 from oxidizer reactor 1680.

As shown, oxygen-providing materials are provided to a third inlet 1604 of combustor 1601. The oxygen-providing material regenerates the reduced oxygen carriers in combustor 1601.

As shown, outlet 1605 of combustor 1601 is in fluid communication with riser 1610, where the oxidized oxygen carriers, after undergoing regeneration, are provided from riser 1610 to the first gas-sealing device 1620 and third gas-sealing device 1650.

First gas-sealing device 1620 includes first inlet 1621 in fluid communication with riser 1610 and second inlet 1622 in fluid communication with a first gas source. First gas-sealing device 1620 further includes an outlet 1623 in fluid communication with first reducer 1630.

First reducer 1630 includes first inlet 1631 and second inlet 1632, such that first reducer 1630 is arranged to operate in co-current flow fashion. First reducer 1630 further includes first outlet 1633 in fluid communication with second gas-sealing device 1640.

First reducer reactor 1630 may be configured as a moving bed reactor. As shown, first oxidized oxygen carriers are provided to the first inlet 1631 of first reducer reactor 1630 from first gas-sealing device 1620. A carbonaceous feedstock is provided to the second inlet 1632 of first reducer reactor 1630.

In various implementations, the carbonaceous feedstock is catalytically decomposed using the first oxygen carriers in first reducer reactor 1630 to form oxidation products. The first oxygen carriers in first reducer reactor 1630 crack higher hydrocarbons into syngas, carbon dioxide (CO₂), and steam (H₂O). In various implementations, the reaction of cracking higher hydrocarbons into syngas, carbon dioxide (CO₂) and steam (H₂O) reduces the formation of tars which may cause issues in downstream processing equipment such as fouling and damage to sensitive operation instrumentation or poisoning of the oxygen carriers in downstream operations. As shown, the oxidation products are provided from second outlet 1634 of first reducer reactor 1630 to second reducer reactor 1660.

The first oxygen carriers undergo reduction by the loss of lattice oxygen during the oxidation of the carbonaceous feedstock in first reducer reactor 1630. As shown, the first outlet 1633 of first reducer 1630 provides the first reduced oxygen carriers to the second gas-sealing device 1640. The first reduced oxygen carriers are provided from the outlet 1643 of second gas-sealing device to the first inlet 1602 of combustor 1601.

Second gas-sealing device 1640 includes first inlet 1641 in fluid communication with first reducer 1630 and second inlet 1642 in fluid communication with a second gas source. Second gas-sealing device 1640 further includes outlet 1643 in fluid communication with combustor 1610.

Third gas-sealing device 1650 includes first inlet 1651 in fluid communication with riser 1610 and second inlet 1652 in fluid communication with a third gas source.

Second reducer 1660 includes first inlet 1661 and second inlet 1662, such that second reducer 1660 is arranged to operate in counter-current flow fashion. Second reducer 1660 further includes first outlet 1663 in fluid communication with fourth gas-sealing device 1670 and second outlet 1664 to provide oxidation products.

Second reducer reactor 1660 may be configured as a moving bed reactor. As shown, second oxidized oxygen carriers are provided to the first inlet 1661 of second reducer reactor 1660 from third gas-sealing device 1650. The oxidation products are provided to the second inlet 1662 of second reducer reactor 1660.

In various implementations, the oxidation products are catalytically decomposed using the second oxygen carriers in second reducer reactor 1660 to form full oxidation products (i.e., carbon dioxide (CO₂) and/or steam (H₂O)). As shown, the full oxidation products are provided to second outlet 1664 of second reducer reactor 1660.

The second oxygen carriers undergo reduction by the less of lattice oxygen during the full oxidation of the oxidation products in second reducer reactor 1660. As shown, the first outlet 1663 of second reducer 1660 provides the second reduced oxygen carriers to the fourth gas-sealing device 1670. The second reduced oxygen carriers are provided from the outlet 1673 of fourth gas-sealing device to the first inlet 1681 of oxidizer reactor 1680.

Fourth gas-sealing device 1670 includes first inlet 1671 in fluid communication with second reducer 1660 and second inlet 1672 in fluid communication with a fourth gas source. Fourth gas-sealing device 1670 further incudes outlet 1673 in fluid communication with oxidizer reactor 1680.

Oxidizer reactor 1680 includes first inlet 1681 and second inlet 1682, such that oxidizer reactor 1680 is arranged to operate in counter-current flow. Oxidizer reactor 1680 further includes first outlet 1683 in fluid communication with fifth gas-sealing device 1690 and second outlet 1684 to provide hydrogen gas (H₂) and/or steam (H₂O).

Oxidizer reactor 1680 may be configured as a moving bed reactor. As shown, second reduced oxygen carriers are provided to the first inlet 1681 of oxidizer reactor 1680 from fourth gas-sealing device 1670. The oxygen-source materials are provided to the second inlet 1682 of oxidizer reactor 1680.

In various implementations, the oxygen-source materials react with the reduced oxygen carriers in oxidizer reactor 1680 to generate hydrogen gas (H₂) and/or steam (H₂O) and partially reduced oxygen carriers. As shown, hydrogen gas (H₂) and/or steam (H₂O) are provided to second outlet 1683 of oxidizer reactor 1680. As shown, the first outlet 1683 of oxidizer reactor 1680 provides the partially reduced oxygen carriers to fifth gas-sealing device 1690. The partially reduced oxygen carriers are provided from the outlet 1693 of fifth gas-sealing device to the second inlet 1603 of combustor 1601.

Fifth gas-sealing device 1690 includes first inlet 1691 in fluid communication with oxidizer reactor 1680 and second inlet 1692 in fluid communication with fifth gas source. Fifth gas-sealing device 1690 further includes an outlet 1693 in fluid communication with combustor 1601.

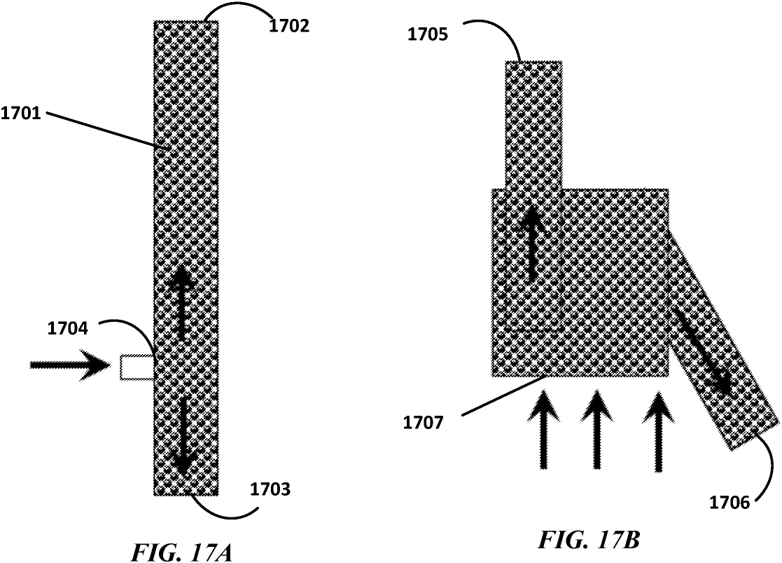

FIG. 17A shows an exemplary standpipe gas-sealing device packed with oxygen carrier particles 1701. During operation, standpipe gas-sealing device has pressure P_{L1} at a top portion 1702 of the exemplary standpipe gas-sealing device and has a pressure P_{L2} at a bottom portion 1703 of the exemplary standpipe gas-sealing device. Sealing gas has a pressure P_{S} which is higher than the pressures of P_{L1} and P_{L2}. Sealing gas is injected into a middle portion 1704 of the exemplary standpipe gas-sealing device. In various implementations, the sealing gas splits and flows in both upwards and downwards directions to provide a gas seal.

FIG. 17B shows an exemplary seal pot gas-sealing device. In some implementations, the exemplary seal pot gas-sealing device may be used in place of, or in addition to, the device shown in FIG. 17A. Similar to FIG. 17A, during operation, the exemplary seal pot gas-sealing device has pressure P_{L1} at a top portion 1705 and a pressure P_{L2} at a bottom portion 1706. Additionally, sealing gas 1707 has a pressure P_{S}.

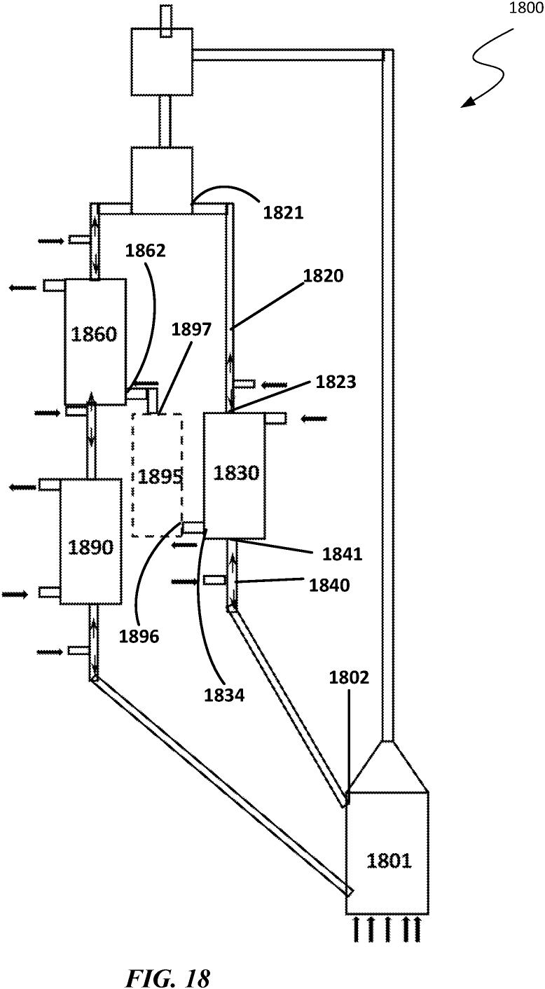

FIG. 18 shows another exemplary system 1800. Unless otherwise indicated, and for the sake of brevity, components in FIG. 18 have the same or similar arrangement and operation as those similarly numbered in system 1600 shown in FIG. 16. System 1800 comprises one or more devices for syngas conditioning and pollutant removal.

As shown, the syngas is provided from the second outlet 1834 of first reducer 1830 to inlet 1896 of the one or more devices for syngas conditioning and pollutant removal 1895. After the syngas has been conditioned and pollutants removed, the syngas is provided from outlet 1897 of the one or more devices for syngas conditioning and pollutant removal 1895 to a second inlet 1862 of second reducer 1860.

As shown, the pressure drops through the one or more syngas conditioning and pollutant removal devices, where second outlet 1834 of first reducer 1830 has pressure P₂, second outlet 1834 has a higher pressure than the second inlet 1862 of second reducer 1860, which has pressure P₁.

As shown, the first inlet 1841 of second gas-sealing device 1840 will have pressure P₂, and the first inlet 1802 of combustor 1802 will have pressure P₁.

As shown, the first inlet 1821 of first gas-sealing device 1820 will have pressure P₀, and the outlet 1823 of first gas-sealing device 1820 will have pressure P₃.

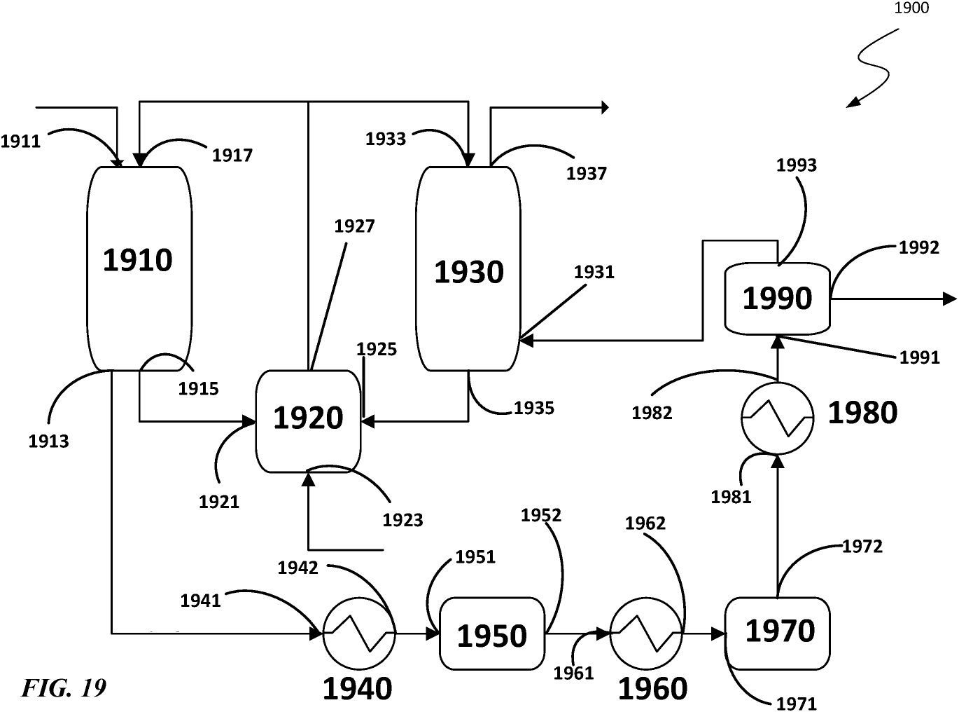

FIG. 19 shows an exemplary system 1900 for processing carbonaceous feedstock. System 1900 comprises first reactor 1910 in fluid communication with second reactor 1920. Second reactor 1920 is in fluid communication with third reactor 1930. Third reactor 1930 is in fluid communication with second reactor 1920. First reactor 1920 is in fluid communication with first heat exchanger 1940. First heat exchanger 1940 is in fluid communication with a high-temperature water gas-shift reactor (HTWGS) 1950. HTWGS 1950 is in fluid communication with second heat exchanger 1960. Second heat exchanger 1960 is in fluid communication with low-temperature water gas-shift reactor (LTWGS) 1970. LTWGS 1970 is in fluid communication with third heat exchanger 1980. Third heat exchanger 1980 is in fluid communication with pressure swing adsorption (PSA) 1990.

As shown, first oxygen carriers are provided to first inlet 1917 of first reactor 1910 and carbonaceous feedstock is provided to second inlet 1911 of first reactor 1910. Typically, first reactor 1910 may be configured as a reducer reactor.

In various implementations, the carbonaceous feedstock is gasified using first oxygen carriers in first reactor 1910 to form syngas. As shown, the syngas is provided from first outlet 1913.

The oxygen carriers undergo reduction by the loss of lattice oxygen during the gasification of the carbonaceous feedstock in first reactor 1910. As shown, the second outlet 1915 of first reactor 1910 is in fluid communication with the first inlet 1921 of second reactor 1920, where the first reduced oxygen carriers are provided from the second outlet 1915 to the first inlet 1921.

As shown, the syngas is provided from the first inlet 1915 of the first reactor 1910 to inlet 1941 of first heat exchanger 1940.

Second reactor 1920 may be configured as a combustor for regeneration of the reduced oxygen carriers. As shown, air is provided to the second inlet 1923 of second reactor 1920. The air regenerates the reduced oxygen carriers in second reactor 1920.

The third inlet 1925 of second reactor 1920 is in fluid communication with first outlet 1935 of third reactor 1930. reduced oxygen carriers are provided to the third inlet 1925 of second reactor 1920. As shown, reduced oxygen carriers are provided to the third inlet 1925 of second reactor 1920 from the first outlet 1935 of third reactor 1930.

As shown, outlet 1927 of second reactor 1920 is in fluid communication with the second inlet 1917 of first reactor 1910 and second inlet 1933 of third reactor 1930, where the first oxidized oxygen carriers and second oxidized oxygen carriers, after undergoing regeneration, are provided from the outlet 1927 to the second inlet 1917 and the second inlet 1933, respectively.

In various implementations, the syngas is provided to the inlet 1941 of first heat exchanger 1940 and is cooled to a temperature between 300° C. to 450° C. The cooled syngas is provided from outlet 1942 of first heat exchanger 1940 to inlet 1951 of HWTGS 1950.

As shown, the syngas stream is provided from outlet 1952 of HWTGS 1950 to inlet 1961 of second heat exchanger 1960, where the syngas is cooled to a temperature between 150° C. to 300° C. The cooled syngas is provided from outlet 1962 of second heat exchanger to inlet 1971 of LWTGS 1970.

As shown, the syngas stream is provided from outlet 1972 of LWTGS 1970 to inlet 1981 of third heat exchanger 1980, where the syngas stream is cooled between 120° C. to 4° C. The cooled syngas is provided from outlet 1982 of third heat exchanger 1980 to inlet 1991 of PSA 1990.

As shown, hydrogen gas (H₂) is provided to first outlet 1992 of PSA 1990. Second outlet 1993 of PSA 1990 is in fluid communication with first inlet 1931 of third reactor 1930. As shown, off-gases are provided from the second outlet 1993 of PSA 1990 to the first inlet 1931 of third reactor 1930.

Typically, third reactor 1930 may be configured as a reducer reactor. As shown, off-gases are provided to the inlet 1931 from second outlet 1993 of PSA 1990.

The inlet 1933 of third reactor 1930 is in fluid communication with outlet 1927 of the second reactor. As shown, oxidized oxygen carriers are provided to the inlet 1933 from the outlet 1925 of second reactor 1920.

As shown, the first outlet 1935 of third reactor 1930 is in fluid communication with the third inlet 1925 of second reactor 1920, where the reduced oxygen carriers are provided from the first outlet 9135 to the third inlet 1925.

As shown, oxidation products are provided from second outlet 1937 of third reactor 1930.

Third reactor 1930 may be configured to recover additional heat energy by combustion of the off-gases provided from PSA 1990 and provides the additional heat energy with the second reduced oxygen carriers to second reactor 1920. Additionally, third reactor 1930 removes the need for the use of an Acid Gas Remover (AGR) unit to capture carbon dioxide (CO₂), such that the generated carbon dioxide (CO₂) in third reactor 1930 is provided to second outlet 1937.

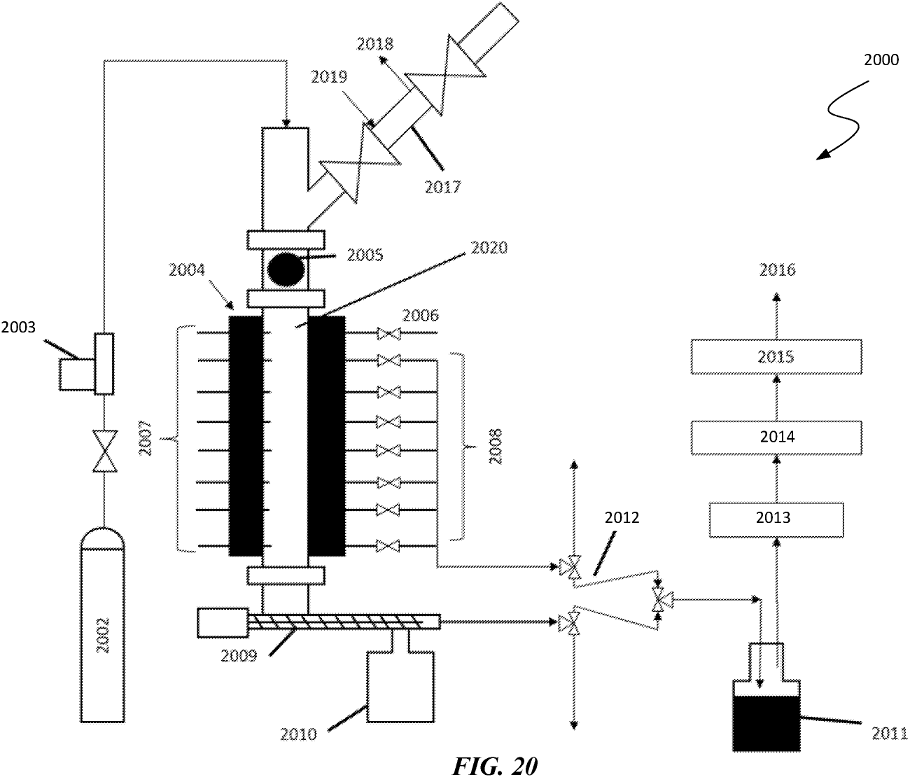

FIG. 20 shows an exemplary moving bed reducer bench scale system 2000. Moving bed reducer bench scale system 2000 comprises a reactor body 2020 which comprises a 5.08 cm diameter column with a heated section of 76.2 cm. In various implementations, iron-titanium complex redox material (ITCMO) particles of the 1000-1500 µm mesh size are utilized as an exemplary material to perform the thermal degradation of the biomass feedstock. In various implementations, woody biomass pellets having a diameter of 6.6 mm and a length between 5 mm to 18 mm are provided as a feedstock. Prior to feeding the biomass pellets, fines are removed from the biomass feed using a No. 6 mesh. The redox particles and the exemplary biomass are mixed together and fed to a moving bed reducer bench scale reactor system 2000.

As shown, system 2000 comprises glass window 2005, inlet port 2017, reactor body 2020, furnace 2004, screw feeder 2009 and bottom particle isolation chamber 2010. As shown, the exemplary feed enters the reactor through the inlet port 2017 which comprises a lock hopper and moves downwards into the heated section of the reactor body 2020. As shown, gases are expelled from inlet port 2017 through vent 2018. As shown, nitrogen gas (N₂) is provided to the inlet port 2017 through inlet 2019. As shown, nitrogen gas (N₂) 2002 is provided to the top of moving bed bench scale reactor system 2000, and the flow is controlled by mass flow controller 2003.

As shown, the furnace 2004 heats the reactor body 2020 to a desired temperature and the temperature may be monitored using thermocouples 2007 at various points along the shaft of the reactor body 2020. As shown, steam is provided to the reactor by port 2006. As shown, the screw feeder 2009 at the bottom of the reactor pushes the reactor solids into the particle isolation chamber 2010 and thus the solids from the reactor keep moving as a packed moving bed reactor. As shown, the gas inlet and outlet ports 2008 across the reactor help in sampling the gases. As shown, the outlet gases are cooled and passed through a desiccant 2013 and the outlet gases are provided to an IR analyzer 2014, and then the outlet gases are provided to an H₂ analyzer 2015. In various implementations, the gas analyzers 2014 and 2015 are used in the experiment are SEIMENS CALOMAT and SEIMENS ULTRAMAT analyzer that work on the principle of infra-red gas detection techniques.

As shown, vents 2016 and 2012 vent out gases, respectively. As shown, steam trap 2011 collects steam from system 2000.

### IV. Exemplary Methods of Operation

Exemplary methods of processing carbonaceous feedstock may comprise various operations. Exemplary systems described above may be used to implement one or more methods described below.

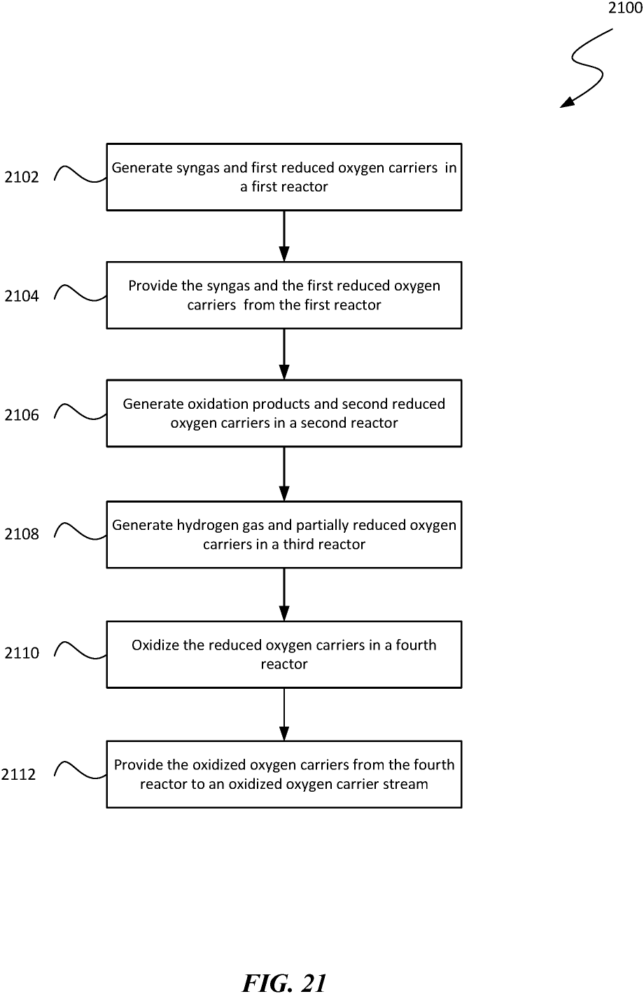

FIG. 21 shows example method 2100 for processing carbonaceous feedstock. As shown, method 2100 includes generating syngas and first reduced oxygen carriers in a first reactor (operation 2102), providing the syngas and the first reduced oxygen carriers from the first reactor (operation 2104), generating oxidation products and second reduced oxygen carriers in a second reactor (operation 2106), generating hydrogen gas and partially reduced oxygen carriers in a third reactor (operation 2108), generating oxidized oxygen carriers in a fourth reactor (operation 2110), and providing the oxidized oxygen carriers from the fourth reactor to the first reactor and the second reactor (operation 2112). Other embodiments may include more or fewer operations. Exemplary systems described and contemplated herein can be utilized to perform the operations of method 2100.

Operating conditions during method 2100 may vary based on the thermodynamic and kinetic properties of the oxygen carriers and the feedstock. In various implementations, elevated temperatures may mean that the system comprise a refractory lined vessel to maintain the temperature within the reactor, and also maintain the structural integrity of the exterior cladding. In various implementations, the exterior of the system may be maintained at low temperatures, thereby allowing the pressure of the system to operate up to 15 MPa.

Exemplary methods include generating syngas and a plurality of first reduced oxygen carriers (operation 2102) by reacting a carbonaceous feedstock with a plurality of first oxidized oxygen carriers. Operation 2102 may be performed in a single first reactor or in a plurality of first reactors.

Carbonaceous feedstock may be screw fed, vibratory tray fed, conveyed pneumatically, or conveyed through a rotary feeder, all of which are able to accomplish steady mass flow. Exemplary systems and methods may utilize these feeders, such that they maintain a pressure above and/or distance away from the injection point on exemplary reactor systems so that premature degradation does not occur. This provides solutions to operability problems when feeding the carbonaceous feedstock into the exemplary systems. In some implementations, the carbonaceous feedstock may be fed at an angle greater than or equal to 60° to prevent fouling of the injection line.

A plurality of first oxidized oxygen carriers is provided to the first reactor from an oxidized oxygen carrier stream. Exemplary syngas may comprise carbon monoxide (CO), hydrogen gas (H₂), carbon dioxide (CO₂), and combinations thereof.

In various implementations, method 2100 may include the first reactor configured as a cross-current first reactor and the cross-current first reactor may operate to generate syngas and a plurality of first reduced oxygen carriers. The carbonaceous feedstock is fed to a first inlet positioned near a top portion of the cross-current first reactor and the plurality of first oxidized oxygen carriers are fed to a second inlet positioned at a top portion of the cross-current first reactor. Oxygen-source materials are provided to a third inlet positioned near a bottom portion of the cross-current first reactor. A plurality of first reduced oxygen carriers is obtained from a first outlet positioned at a bottom portion of the cross-current first reactor. The syngas is obtained from a second outlet positioned near a middle portion of the cross-current first reactor.

In various implementations, method 2100 may include the first reactor configured as a counter-current first reactor and the counter-current first reactor may operate to produce oxidation products and a plurality of first reduced oxygen carriers. The carbonaceous feedstock is fed to a first inlet positioned near a middle portion of the counter-current first reactor and the plurality of first oxidized oxygen carriers are fed to a second inlet positioned at a top portion of the counter-current first reactor. Oxygen-source materials are provided to a third inlet positioned near a bottom portion of the counter-current first reactor. A plurality of first reduced oxygen carriers is obtained from a first outlet positioned at a bottom portion of the counter-current first reactor. The oxidation products are obtained from a second outlet positioned near a top portion of the counter-current first reactor.

In various implementations, method 2100 may include providing the syngas from an outlet of the first reactor to an inlet of the second reactor and to one or more chemical processes. The outlet of the first reactor is in fluid communication with the inlet of the second reactor and the outlet of the first reactor in fluid communication with the one or more chemical processes.

In various implementations, the first reactor may be operated at a temperature of about 300° C. to about 1500° C.; 350° C. to 1500° C.; 400° C. to 1500° C.; 450° C. to 1500° C.; 450° C. to 1400° C.; 450° C. to 1300° C.; 500° C. to 1300° C.; 550° C. to 1300° C.; 550° C. to 1250° C.; 600° C. to 1250° C.; 500° C. to 1200° C.; 650° C. to 1200° C.; 650° C. to 1150° C.; or 700° C. to 1100° C. In various implementations, the first reactor may be operated at a temperature of no less than 300° C.; no less than 350° C.; no less than 400° C.; no less than 450° C.; no less than 500° C.; no less than 550° C.; no less than 600° C.; no less than 650° C.; no less than 700° C.; no less than 750° C.; no less than 800° C.; no less than 850° C.; no less than 900° C.; no less than 950° C.; no less than 1000° C.; no less than 1050° C.; no less than 1100° C.; no less than 1150° C.; no less than 1200° C.; no less than 1250° C.; no less than 1300° C.; no less than 1350° C.; no less than 1400° C.; or no less than 1450° C. In various implementations, the first reactor may be operated at a temperature of no greater than 1500° C.; no greater than 1475° C.; no greater than 1425° C.; no greater than 1375° C.; no greater than 1325° C.; no greater than 1275° C.; no greater than 1225° C.; no greater than 1175° C.; no greater than 1125° C.; no greater than 1075° C.; no greater than 1025° C.; no greater than 975° C.; no greater than 925° C.; no greater than 875° C.; no greater than 825° C.; no greater than 775° C.; no greater than 725° C.; no greater than 675° C.; no greater than 625° C.; no greater than 575° C.; no greater than 525° C.; no greater than 475° C.; no greater than 425° C.; no greater than 375° C.; or no greater than 325° C.

In various implementations, the first reactor may be operated at a pressure of about 0 MPa to about 15 MPa; 0 MPa to 14 MPa; 0.1 MPa to 14 MPa; 0.1 to 13 MPa; 0.1 to 12 MPa; 0.1 MPa to 11 MPa; 0.1 MPa to 10 MPa; 0.1 MPa to 9 MPa; 0.1 MPa to 8 MPa; 0.1 MPa to 7 MPa; 0.1 MPa to 6 MPa; 0.1 MPa to 5 MPa; 0.1 MPa to 4 MPa; 0.1 MPa to 3 MPa; 0.1 MPa to 2 MPa; 0.1 MPa to 1 MPa; 0.1 MPa to 0.5 MPa; 1 MPa to 15 MPa; 2 MPa to 15 MPa; 3 MPa to 15 MPa; 4 MPa to 15 MPa; 5 MPa to 15 MPa; 10 MPa to 15 MPa; 11 MPa to 15 MPa; 12 MPa to 15 MPa; 13 MPa to 15 MPa; or 14 MPa to 15 MPa. In various implementations, the first reactor may be operated at a pressure of no less than 0 MPa; no less than 0.2 MPa; no less than 0.3 MPa; no less than 0.4 MPa; no less than 0.5 MPa; no less than 0.6 MPa; no less than 0.7 MPa; no less than 0.8 MPa; no less than 0.9 MPa; no less than 1 MPa; no less than 2 MPa; no less than 5 MPa; no less than 8 MPa; no less than 10 MPa; no less than 12 MPa; or no less than 14 MPa. In various implementations the first reactor may be operated at a pressure of no greater than 15 MPa; no greater than 14 MPa; no greater than 13 MPa; no greater than 12 MPa; no greater than 11 MPa; no greater than 10 MPa; no greater than 9 MPa; no greater than 7 MPa; no greater than 6 MPa ;no greater than 4 MPa; no greater than 3 MPa; no greater than 1 MPa; no greater than 0.8 MPa; no greater than 0.5 MPa or no greater than 0.3 MPa.

Syngas is provided from the first reactor to one or more chemical processes located downstream from exemplary systems and methods, and the plurality of first reduced oxygen carriers are provided to the reduced oxygen carrier stream (operation 2104). The first reactor is in fluid communication with the one or more chemical processes and is in fluid communication with the reduced oxygen carrier stream. The reduced oxygen carrier stream is in fluid communication with a fourth reactor and transport the plurality of first reduced oxygen carriers to the fourth reactor.

The second reactor operates to generate oxidation products and second reduced oxygen carriers (operation 2106). The second reactor receives a plurality of second oxidized oxygen carriers from an oxidized oxygen carrier stream. The second reactor may react waste gas with a plurality of second oxidized oxygen carriers to generate the oxidation products and the second reduced oxygen carriers. Exemplary oxidation products may comprise completely oxidized products, partially oxidized products, or upgraded syngas. The second reduced oxygen carriers are provided from the second reactor to a third reactor.

In various implementations, method 2100 may include providing a plurality of waste gas streams to a plurality of second inlets of the second reactor. The plurality of second inlets of the second reactor are in fluid communication with the one or more chemical processes.

In various implementations, method 2100 may include providing gases from the second outlet of the third reactor to a second inlet of the second reactor..

In various implementations, method 2100 may include providing the oxidation products from a second outlet of the second reactor to a second inlet of the third reactor.

In various implementations, method 2100 may modified for a plurality of second reactors. Method 2100 may include generating oxidation products and a plurality of second reduced oxygen carriers in the plurality of second reactors. Method 2100 may include providing the plurality of second oxidized oxygen carriers to a plurality of first inlets of the plurality of second reactors. Method 2100 may include providing oxidation products from a plurality of second outlets of the plurality of second reactors. Method 2100 may include providing a plurality of second reduced oxygen carriers to a first inlet of the third reactor.

In various implementations, the second reactor may be operated at a temperature between about 300° C. to 1500° C.; 350° C. to 1500° C.; 400° C. to 1500° C.; 450° C. to 1500° C.; 450° C. to 1400° C.; 450° C. to 1300° C.; 500° C. to 1300° C.; 550° C. to 1300° C.; 550° C. to 1250° C.; 600° C. to 1250° C.; 600° C. to 1200° C.; 650° C. to 1200° C.; 650° C. to 1150° C.; or 750° C. to 1150° C. In various implementations, the second reactor may be operated at a temperature of no less than 300° C.; no less than 350° C.; no less than 400° C.; no less than 450° C.; no less than 500° C.; no less than 550° C.; no less than 600° C.; no less than 650° C.; no less than 700° C.; no less than 750° C.; no less than 800° C.; no less than 850° C.; no less than 900° C.; no less than 950° C.; no less than 1000° C.; no less than 1050° C.; no less than 1100° C.; no less than 1150° C.; no less than 1200° C.; no less than 1250° C.; no less than 1300° C.; no less than 1350° C.; no less than 1400° C.; or no less than 1450° C. In various implementations, the second reactor may be operated at a temperature of no greater than 1500° C.; no greater than 1475° C.; no greater than 1425° C.; no greater than 1375° C.; no greater than 1325° C.; no greater than 1275° C.; no greater than 1225° C.; no greater than 1175° C.; no greater than 1125° C.; no greater than 1075° C.; no greater than 1025° C.; no greater than 975° C.; no greater than 925° C.; no greater than 875° C.; no greater than 825° C.; no greater than 775° C.; no greater than 725° C.; no greater than 675° C.; no greater than 625° C.; no greater than 575° C.; no greater than 525° C.; no greater than 475° C.; no greater than 425° C.; no greater than 375° C.; or no greater than 325° C.

In various implementations, the second reactor may be operated at a pressure between 0 MPa to 15 MPa; 0 MPa to 14 MPa; 0.1 MPa to 14 MPa; 0.1 MPa to 13 MPa; 0.1 MPa to 12 MPa; 0.1 MPa to 11 MPa; 0.1 MPa to 10 MPa; 0.1 MPa to 9 MPa; 0.1 MPa to 8 MPa; 0.1 MPa to 7 MPa; 0.1 MPa to 6 MPa; 0.1 MPa to 5 MPa; 0.1 MPa to 4 MPa; 0.1 MPa to 3 MPa; 0.1 MPa to 2 MPa; 0.1 MPa to 1 MPa; 0.1 MPa to 0.5 MPa; 1 MPa to 15 MPa; 2 MPa to 15 MPa; 3 MPa to 15 MPa; 4 MPa to 15 MPa; 5 MPa to 15 MPa; 10 MPa to 15 MPa; 11 MPa to 15 MPa; 12 MPa to 15 MPa; 13 MPa to 15 MPa; or 14 MPa to 15 MPa. In various implementations, the second reactor may be operated at a pressure of no less than 0 MPa; no less than 0.2 MPa; no less than 0.3 MPa; no less than 0.4 MPa; no less than 0.5 MPa; no less than 0.6 MPa; no less than 0.7 MPa; no less than 0.8 MPa; no less than 0.9 MPa; no less than 1 MPa; no less than 2 MPa; no less than 5 MPa; no less than 8 MPa; no less than 10 MPa; no less than 12 MPa; or no less than 14 MPa. In various implementations the second reactor may be operated at a pressure of no greater than 15 MPa; no greater than 14 MPa; no greater than 13 MPa; no greater than 12 MPa; no greater than 11 MPa; no greater than 10 MPa; no greater than 9 MPa; no greater than 7 MPa; no greater than 6 MPa ;no greater than 4 MPa; no greater than 3 MPa; no greater than 1 MPa; no greater than 0.8 MPa; no greater than 0.5 MPa; or no greater than 0.3 MPa.

The third reactor operates to generate hydrogen gas (H₂) and a plurality of partially reduced oxygen carriers (operation 2108). The third reactor receives the plurality of second reduced oxygen carriers from the second reactor. The third reactor reacts oxygen-source materials and the plurality of second reduced oxygen carriers to generate the hydrogen gas (H₂) and partially reduced oxygen carriers. Operation 2108 may include providing oxygen-source materials and the plurality of second reduced oxygen carriers to the third reactor in co-current flow fashion. Operation 2108 may include providing oxygen-source materials and the plurality of second reduced oxygen carriers to the third reactor in counter-current flow fashion.

In various implementations, method 2100 may include providing a plurality of second reduced oxygen carriers to the plurality of first inlets of the plurality of the third reactors from the plurality of first outlets of the plurality of the second reactors. The plurality of third reactors provides hydrogen gas (H₂) to a plurality of second outlets of the plurality of third reactors. The plurality of third reactors provides a plurality of partially reduced oxygen carriers to the reduced oxygen carrier stream. The plurality of third reactors is in fluid communication with the reduced oxygen carrier stream.

In various implementations, the third reactor may be operated at a temperature between about 300° C. to 1500° C.; 350° C. to 1500° C.; 400° C. to 1500° C.; 450° C. to 1500° C.; 450° C. to 1400° C.; 450° C. to 1300° C.; 500° C. to 1300° C.; 550° C. to 1300° C.; 550° C. to 1250° C.; 600° C. to 1250° C.; 600° C. to 1200° C.; 650° C. to 1200° C.; 650° C. to 1150° C.; or 750° C. to 1150° C. In various implementations, the third reactor may be operated at a temperature of no less than 300° C.; no less than 350° C.; no less than 400° C.; no less than 450° C.; no less than 500° C.; no less than 550° C.; no less than 600° C.; no less than 650° C.; no less than 700° C.; no less than 750° C.; no less than 800° C.; no less than 850° C.; no less than 900° C.; no less than 950° C.; no less than 1000° C.; no less than 1050° C.; no less than 1100° C.; no less than 1150° C.; no less than 1200° C.; no less than 1250° C.; no less than 1300° C.; no less than 1350° C.; no less than 1400° C.; or no less than 1450° C. In various implementations, the third reactor may be operated at a temperature of no greater than 1500° C.; no greater than 1475° C.; no greater than 1425° C.; no greater than 1375° C.; no greater than 1325° C.; no greater than 1275° C.; no greater than 1225° C.; no greater than 1175° C.; no greater than 1125° C.; no greater than 1075° C.; no greater than 1025° C.; no greater than 975° C.; no greater than 925° C.; no greater than 875° C.; no greater than 825° C.; no greater than 775° C.; no greater than 725° C.; no greater than 675° C.; no greater than 625° C.; no greater than 575° C.; no greater than 525° C.; no greater than 475° C.; no greater than 425° C.; no greater than 375° C.; or no greater than 325° C.

In various implementations, the third reactor may be operated at a pressure between 0 MPa to 15 MPa; 0 MPa to 14 MPa; 0.1 MPa to 14 MPa; 0.1 MPa to 13 MPa; 0.1 MPa to 12 MPa; 0.1 MPa to 11 MPa; 0.1 MPa to 10 MPa; 0.1 MPa to 9 MPa; 0.1 MPa to 8 MPa; 0.1 MPa to 7 MPa; 0.1 MPa to 6 MPa; 0.1 MPa to 5 MPa; 0.1 MPa to 4 MPa; 0.1 MPa to 3 MPa; 0.1 MPa to 2 MPa; 0.1 MPa to 1 MPa; 0.1 MPa to 0.5 MPa; 1 MPa to 15 MPa; 2 MPa to 15 MPa; 3 MPa to 15 MPa; 4 MPa to 15 MPa; 5 MPa to 15 MPa; 10 MPa to 15 MPa; 11 MPa to 15 MPa; 12 MPa to 15 MPa; 13 MPa to 15 MPa; or 14 MPa to 15 MPa. In various implementations, the third reactor may be operated at a pressure of no less than 0 MPa; no less than 0.2 MPa; no less than 0.3 MPa; no less than 0.4 MPa; no less than 0.5 MPa; no less than 0.6 MPa; no less than 0.7 MPa; no less than 0.8 MPa; no less than 0.9 MPa; no less than 1 MPa; no less than 2 MPa; no less than 5 MPa; no less than 8 MPa; no less than 10 MPa; no less than 12 MPa; or no less than 14 MPa. In various implementations the third reactor may be operated at a pressure of no greater than 15 MPa; no greater than 14 MPa; no greater than 13 MPa; no greater than 12 MPa; no greater than 11 MPa; no greater than 10 MPa; no greater than 9 MPa; no greater than 7 MPa; no greater than 6 MPa ;no greater than 4 MPa; no greater than 3 MPa; no greater than 1 MPa; no greater than 0.8 MPa; no greater than 0.5 MPa; or no greater than 0.3 MPa.

The hydrogen gas (H₂) is obtained from the third reactor. The plurality of partially reduced oxygen carriers is provided from the third reactor to a reduced oxygen carrier stream. The third reactor is in fluid communication with the reduced oxygen carrier stream. The reduced oxygen carrier stream is in fluid communication with a fourth reactor and transports the plurality of partially reduced oxygen carriers to the fourth reactor.

The fourth reactor operates to oxidize the reduced oxygen carriers (operation 2110). The fourth reactor receives the plurality of first reduced oxygen carriers and the plurality of partially reduced oxygen carriers from the reduced oxygen carrier stream. The fourth reactor is in fluid communication with the reduced oxygen carrier stream. The fourth reactor reacts oxygen-providing materials and the plurality of second reduced oxygen carriers and the plurality of partially reduced oxygen carriers to generate oxidized oxygen carriers and fourth reactor products.

In various implementations, the fourth reactor may be operated at a temperature between about 300° C. to 1500° C.; 350° C. to 1500° C.; 400° C. to 1500° C.; 450° C. to 1500° C.; 450° C. to 1400° C.; 450° C. to 1300° C.; 500° C. to 1300° C.; 550° C. to 1300° C.; 550° C. to 1250° C.; 600° C. to 1250° C.; 600° C. to 1200° C.; 650° C. to 1200° C.; 650° C. to 1150° C.; or 750° C. to 1150° C. In various implementations, the fourth reactor may be operated at a temperature of no less than 300° C.; no less than 350° C.; no less than 400° C.; no less than 450° C.; no less than 500° C.; no less than 550° C.; no less than 600° C.; no less than 650° C.; no less than 700° C.; no less than 750° C.; no less than 800° C.; no less than 850° C.; no less than 900° C.; no less than 950° C.; no less than 1000° C.; no less than 1050° C.; no less than 1100° C.; no less than 1150° C.; no less than 1200° C.; no less than 1250° C.; no less than 1300° C.; no less than 1350° C.; no less than 1400° C.; or no less than 1450° C. In various implementations, the fourth reactor may be operated at a temperature of no greater than 1500° C.; no greater than 1475° C.; no greater than 1425° C.; no greater than 1375° C.; no greater than 1325° C.; no greater than 1275° C.; no greater than 1225° C.; no greater than 1175° C.; no greater than 1125° C.; no greater than 1075° C.; no greater than 1025° C.; no greater than 975° C.; no greater than 925° C.; no greater than 875° C.; no greater than 825° C.; no greater than 775° C.; no greater than 725° C.; no greater than 675° C.; no greater than 625° C.; no greater than 575° C.; no greater than 525° C.; no greater than 475° C.; no greater than 425° C.; no greater than 375° C.; or no greater than 325° C.

In various implementations, the fourth reactor may be operated at a pressure between 0 MPa to 15 MPa; 0 MPa to 14 MPa; 0.1 MPa to 14 MPa; 0.1 MPa to 13 MPa; 0.1 MPa to 12 MPa; 0.1 MPa to 11 MPa; 0.1 MPa to 10 MPa; 0.1 MPa to 9 MPa; 0.1 MPa to 8 MPa; 0.1 MPa to 7 MPa; 0.1 MPa to 6 MPa; 0.1 MPa to 5 MPa; 0.1 MPa to 4 MPa; 0.1 MPa to 3 MPa; 0.1 MPa to 2 MPa; 0.1 MPa to 1 MPa; 0.1 MPa to 0.5 MPa; 1 MPa to 15 MPa; 2 MPa to 15 MPa; 3 MPa to 15 MPa; 4 MPa to 15 MPa; 5 MPa to 15 MPa; 10 MPa to 15 MPa; 11 MPa to 15 MPa; 12 MPa to 15 MPa; 13 MPa to 15 MPa; or 14 MPa to 15 MPa. In various implementations, the fourth reactor may be operated at a pressure of no less than 0 MPa; no less than 0.2 MPa; no less than 0.3 MPa; no less than 0.4 MPa; no less than 0.5 MPa; no less than 0.6 MPa; no less than 0.7 MPa; no less than 0.8 MPa; no less than 0.9 MPa; no less than 1 MPa; no less than 2 MPa; no less than 5 MPa; no less than 8 MPa; no less than 10 MPa; no less than 12 MPa; or no less than 14 MPa. In various implementations the fourth reactor may be operated at a pressure of no greater than 15 MPa; no greater than 14 MPa; no greater than 13 MPa; no greater than 12 MPa; no greater than 11 MPa; no greater than 10 MPa; no greater than 9 MPa; no greater than 7 MPa; no greater than 6 MPa ;no greater than 4 MPa; no greater than 3 MPa; no greater than 1 MPa; no greater than 0.8 MPa; no greater than 0.5 MPa; or no greater than 0.3 MPa.

The fourth reactor provides the oxidized oxygen carriers to an oxidized oxygen carrier stream (operation 2112). The fourth reactor is in fluid communication with the oxidized oxygen carrier stream. The oxidized oxygen carrier stream transports a plurality of first oxidized oxygen carriers to the first reactor and a plurality of second oxidized oxygen carriers to the second reactor.

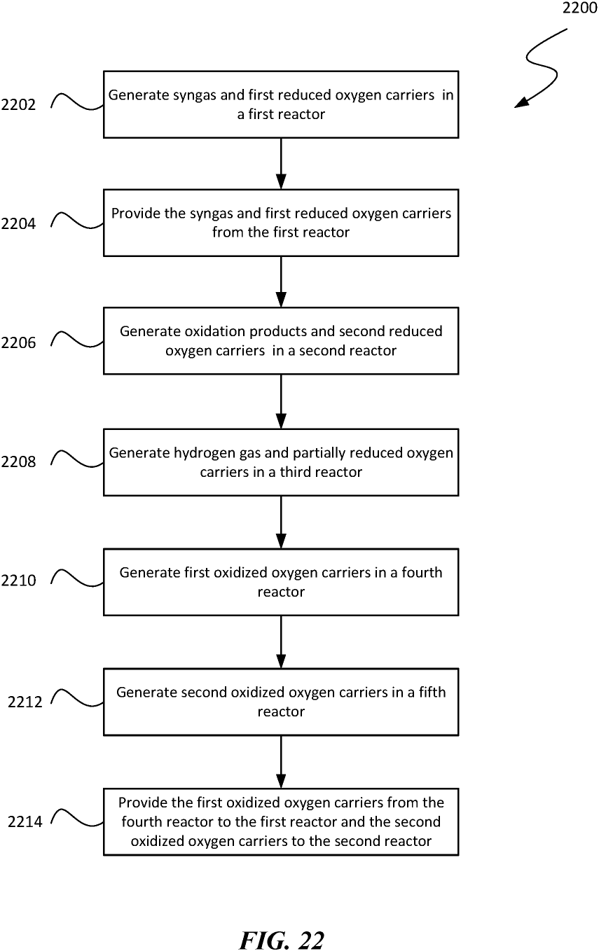

FIG. 22 shows example method 2200 for processing carbonaceous feedstock. Unless otherwise indicated, and for the sake of brevity, operations in FIG. 22 have the same or similar operations as those similarly numbered in method 2100 shown in FIG. 21.

As shown, method 2200 includes generating syngas and first reduced oxygen carriers in a first reactor (operation 2202), providing the syngas and first reduced oxygen carriers from the first reactor (operation 2204), generating oxidation products and second reduced oxygen carriers in a second reactor (operation 2206), generating hydrogen gas and partially reduced oxygen carriers in a third reactor (operation 2208), generating first oxidized oxygen carriers in a fourth reactor (operation 2210), generating second oxidized oxygen carriers in a fifth reactor (operation 2212), and providing the first oxidized oxygen carriers from the fourth reactor to the first reactor and the second oxidized oxygen carriers to the second reactor (operation 2214).

In various implementations, the syngas may be provided from the first reactor to the second reactor in a fraction between 0.1 to 1; 0.2 to 1; 0.3 to 1; 0.4 to 1; 0.5 to 1; 0.6 to 1; 0.7 to 1; 0.8 to 1; 0.9 to 1; or about 1. In various implementations, the syngas may be provided from the first reactor to the second reactor in a fraction of at least 0.1; at least 0.2; at least 0.3; at least 0.4; at least 0.5; at least 0.6; at least 0.7; at least 0.8; or at least 0.9. In various implementations, the syngas may be provided from the first reactor to the second reactor in a fraction no greater than 1.0; no greater than 0.9; no greater than 0.8; no greater than 0.7; no greater than 0.6; no greater than 0.5; no greater than 0.4; no greater than 0.3; no greater than 0.2; or no greater than 0.1

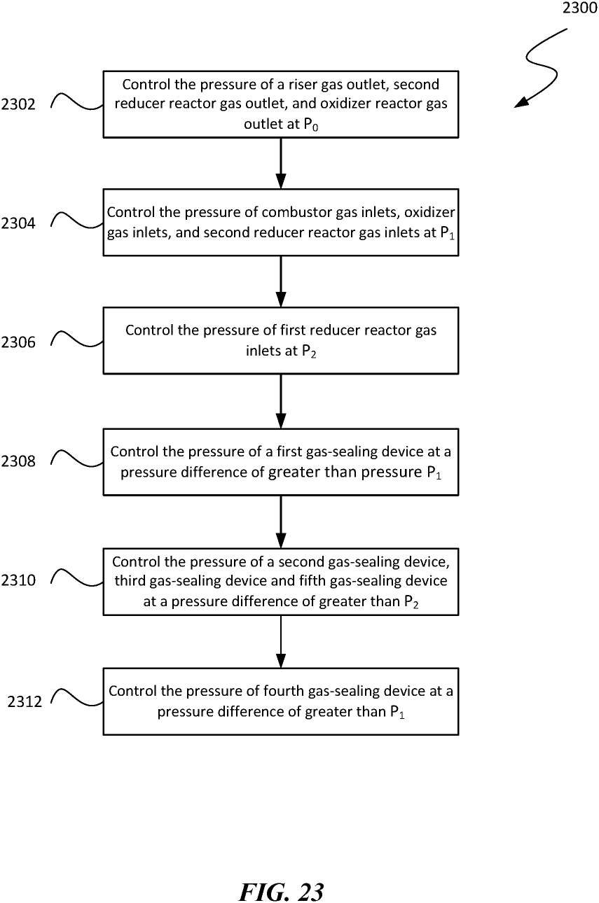

FIG. 23 shows example method 2300 for controlling the pressure of an exemplary system for processing carbonaceous feedstock. As shown, method 2300 includes controlling the pressure of a riser gas outlet, a second reducer reactor gas outlet, and an oxidizer reactor gas outlet to be pressure P₀ (operation 2302). The pressure can be manipulated by use of equipment such as compressors, blowers, vacuum pumps or by varying the gas flow rate for the flow streams. Method 2300 also includes controlling the pressure of a first gas-sealing device at a pressure difference greater than pressure P₀ (operation 2308), where the first gas-sealing device is in fluid communication with the riser gas outlet and second reducer reactor gas outlet.

Method 2300 also includes controlling the pressure of combustor gas inlets, oxidizer gas inlets, and second reducer reactor gas inlets to be pressure P₁ (operation 2304). Pressure P₁ is greater than pressure P₀ because the gas inlet (P₁) would flow towards the gas outlet (P₀). The pressure can be manipulated by use of equipment such as compressors, blowers, vacuum pumps or by varying the gas flow rate for the flow streams. Method 2300 includes controlling a second gas-sealing device, a third gas-sealing device, and a fifth gas-sealing device having a pressure greater than pressure P₁.

First reducer reactor gas inlets have a pressure of P₂. Method 2300 includes controlling the pressure of fourth gas-sealing device at a pressure difference greater than P₂ (operation 2312).

### V. Experimental Data

Various data were experimentally generated, and the results are described below.

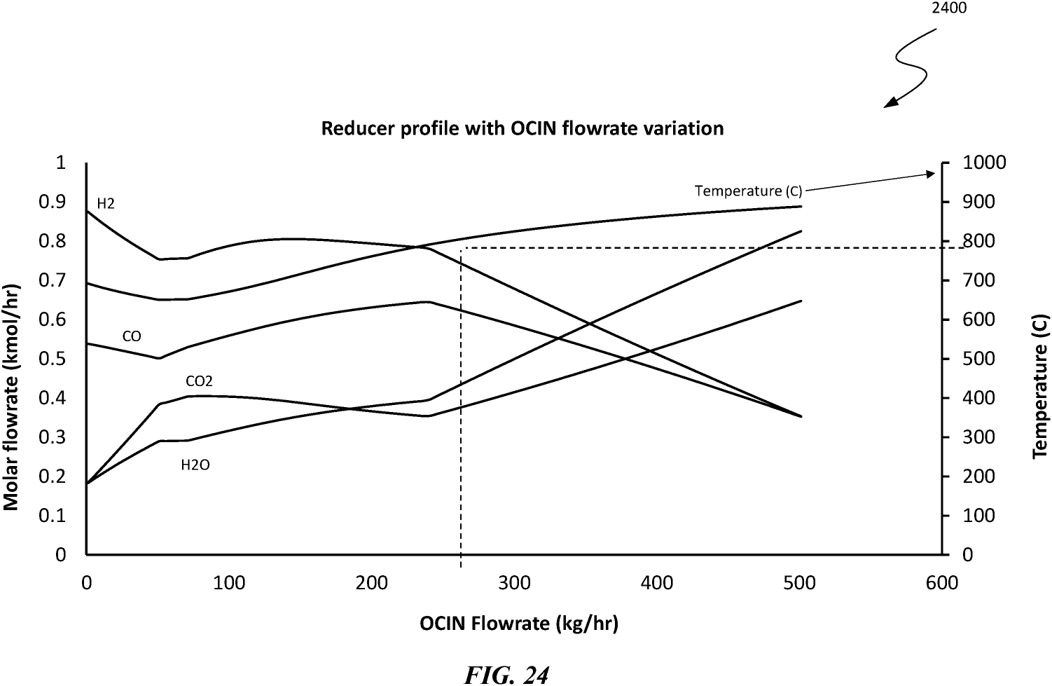

FIG. 24 shows thermodynamic simulation data of molar flowrate versus temperature versus oxygen carrier particle (OCIN) flowrate for a reducer outlet gas generated using the system shown in FIG. 19. As observed from reducer flowrate profile in FIG. 24, the increase in the flowrate of the oxygen carrier causes an increase in the full combustion products such as carbon dioxides (CO₂) and/or steam (H₂O), while a decrease in the syngas yield (CO+H₂) occurs. It was observed that the increase in the oxygen carrier causes an increase in the total oxygen supplied to the reducer. As a result, combustion becomes favorable at that point. It was observed that to achieve better quality syngas, the amount of oxygen carriers provided to the reducer reactor should be lower. However, it was further observed that as the oxygen carrier flowrate increased the temperature of the reducer reactor subsequently also increased. The gasification kinetics slow down below 800° C. As a result, the OCIN flowrate should at least a temperature of greater than 800° C. at the reducer outlet. Based on these two criteria, the OCIN flowrate was fixed to 256 kg/hr for experimental purposes.

TABLE 1

Proximate and ultimate analysis of the biomass used during experiments

| | Biomass |
|---|---|
| Proximate analysis, wt%, as received | |
| Moisture | 5.52 |
| Ash | 0.57 |
| Volatile | 78.06 |
| Fixed Carbon | 15.85 |
| Sulfur | 0.12 |
| Ultimate Analysis, wt%, dry basis | |
| Carbon | 51.55 |
| Hydrogen | 6.09 |
| Nitrogen | 0.15 |
| Sulfur | 0.12 |
| Ash | 0.57 |
| Oxygen | 41.49 |

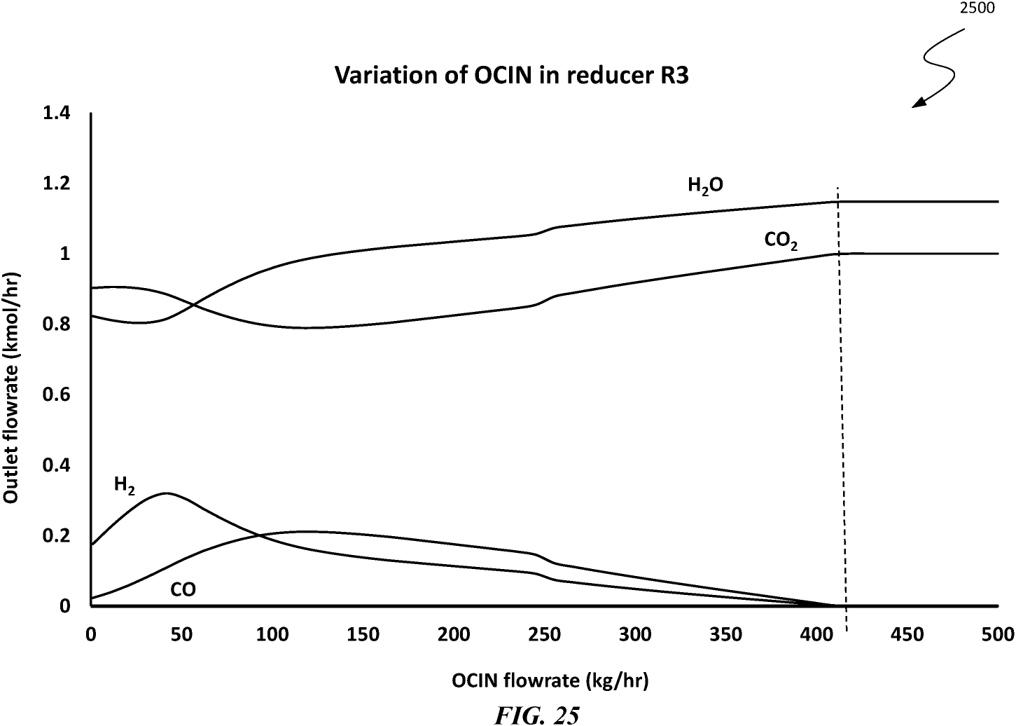

FIG. 25 shows thermodynamic simulation data of outlet flowrate versus oxygen carrier flowrate for reducer outlet gas generated using exemplary system 1900. The off-gases from the hydrogen gas (H₂) production were input in a bottom inlet of the third reactor, where the hydrogen gas (H₂) flowed upwards in a counter-current flow fashion with respect to the oxygen carriers flowing from a top portion of the third reactor to a bottom potion of the third reactor. As the amount of oxygen carriers increase, the full combustion products of steam (H₂O) and/or carbon dioxide (CO₂) increase in the third reactor outlet. The flowrate of the third reactor was set to 418 kg/hr to get complete combustion of the off-gases from the hydrogen gas (H₂) production plant. The carbon dioxide (CO₂) received from the outlet of the third reactor was capture ready for a carbon dioxide (CO₂) stream after knocking off the water by cooling the steam.

The exemplary system 1900 was compared to a conventional process without a second reducer 1930. The conventional process used an acid gas remover (AGR) to capture carbon dioxide (CO₂) in the off gases received from the pressure swing absorber (PSA). The AGR generates a carbon dioxide (CO₂) stream and flares off the remaining components in the off gases received from the PSA.

It was observed that the combustor in the conventional process produces an exothermic heat of 18.96 kW, whereas the combustor in exemplary system 1900 produces an exothermic heat of 32.87 kW, thus increasing the amount of heat by about 70% for the same amount of generated syngas. Therefore, adding an additional reducer into the system, the proposed system can recover additional heat from the system that can be used for steam generation for the water gas shift reactor. This is just an example how the proposed system can recover additional heat along with CO₂ capture while eliminating the need for any capital and energy intensive AGR plant.

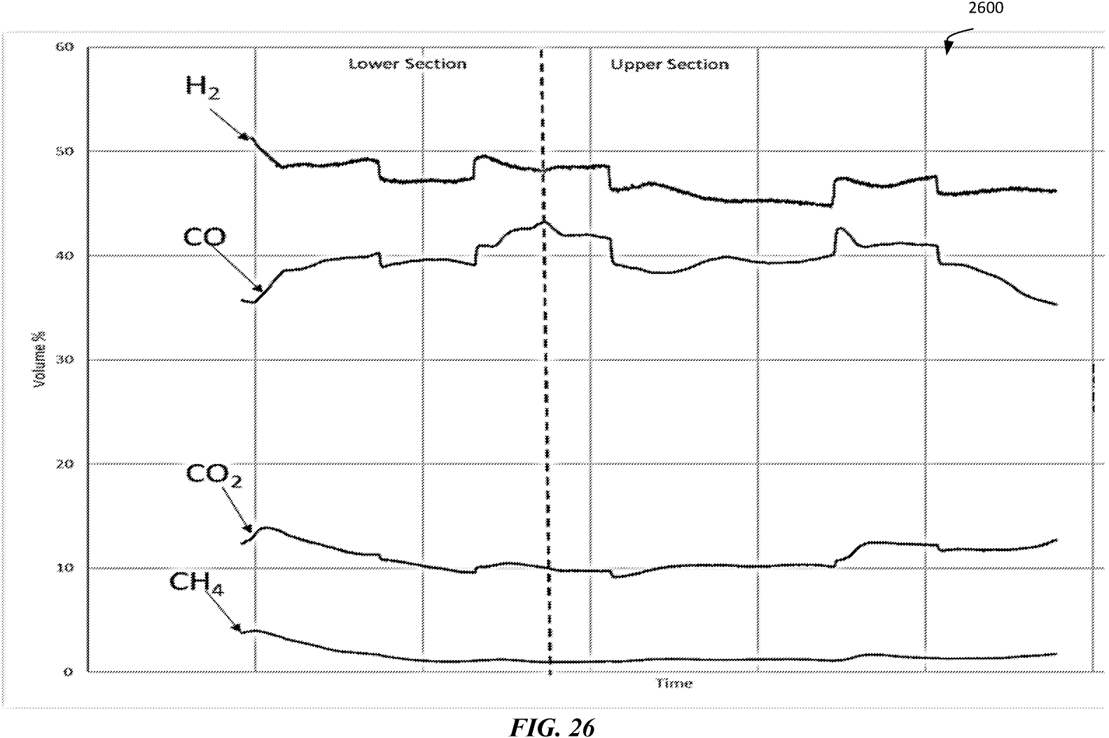

As can be observed from the results of the moving bed reducer bench scale system 2000 in FIG. 26, the lower section was first sent to the gas analysis, and the following gas compositions were achieved: 48.4% H₂, 39.3% CO, 11.3% CO₂, and 0.92% CH₄. There is a low flow of N₂ through the reactor that is introduced at the top of the bed, and this N₂ splits out through the outlet of both the upper and lower sections of the bed. Therefore, the total gas concentrations do not add perfectly to 100%.

The determination of the quantity of syngas produced was completed by introducing a stream of pure O₂ directly before the gas analysis system to mix with the produced syngas. This allowed a known quantity to be introduced into the gas stream and based on the volume percentage shown on the analyzer, the quantity of each component could be calculated. The regions where O₂ was injected into the product gas stream are the sudden decreases in volume percentage (best seen on the H₂ and CO traces).

Before switching the feed to the gas analysis system to the upper section of the bed, the O₂ was switched off, resulting in the sudden increase in volume percentages for each component. At the point where the outlet to the analyzers was switched, there is not any appreciable change in composition of the syngas, showing that a modular system is practical to maintain a high purity syngas production with multiple reducer reactors. Again, the decrease in volume percentages for each component is due to the injection of O₂ as a tracer gas in the outlet stream. Comparing the upper and lower sections of the bench unit, it can be seen that the composition does not change going from the lower section outlet to the upper section outlet.

For reasons of completeness, the following Embodiments are provided:

Embodiment 1. A reactor system, comprising:
a first reactor comprising:
   a first inlet in fluid communication with an oxidized oxygen carrier stream;
   a second inlet configured to receive carbonaceous feedstock;
   a first outlet in fluid communication with a reduced oxygen carrier stream; and
   a second outlet in fluid communication with one or more processes;
a second reactor comprising:
   a first inlet in fluid communication with the oxidized oxygen carrier stream; and
   a first outlet;
a third reactor comprising:
   a first inlet in fluid communication with the first outlet of the second reactor;
   a first outlet being in fluid communication with the reduced oxygen carrier stream;
   the third reactor being in series with the second reactor; and
   the first reactor being in parallel with the second reactor and the third reactor; and
a fourth reactor comprising:
   an inlet in fluid communication with the reduced oxygen carrier stream;
   an outlet in fluid communication with the oxidized oxygen carrier stream; and the fourth reactor being configured as a fluidized bed reactor.

Embodiment 2. The reactor system according to Embodiment 1, the second reactor further comprising:
a second inlet in fluid communication with a second outlet of the third reactor, the second reactor being in series with the third reactor; and
the second inlet configured to receive gases from the second outlet of the third reactor.

Embodiment 3. The reactor system according to Embodiment 1 or Embodiment 2, the system further comprising:
a plurality of first reactors, each of the plurality of first reactors comprising:
   a first inlet in fluid communication with the oxidized oxygen carrier stream;
   a first outlet in fluid communication with the reduced oxygen carrier stream; and
   a second outlet in fluid communication with the one or more processes.

Embodiment 4. The reactor system according to any one of Embodiments 1-3, the system further comprising:
a plurality of second reactors, each of the plurality of second reactors comprising:
   a first inlet in fluid communication with the oxidized oxygen carrier stream;
   a first outlet in fluid communication with the third reactor;
   a second inlet in fluid communication with the one or more processes; and
   a second outlet configured to provide oxidation products.

Embodiment 5. The reactor system according to any one of Embodiments 1-4, the system further comprising:
a plurality of third reactors in series with the plurality of second reactors, each of the plurality of third reactors comprising:
   a first inlet in fluid communication with one of the first outlets of the plurality of second reactors:
   a second inlet configured to receive steam;
   a first outlet in fluid communication with the reduced oxygen carrier stream; and
   a second outlet configured to provide an outlet stream comprising hydrogen gas (H₂).

Embodiment 6. The reactor system according to any one of Embodiments 1-5, wherein a second outlet of the second reactor is in fluid communication with a second inlet of the third reactor.

Embodiment 7. The reactor system according to any one of Embodiments 1-6, wherein the second outlet of the first reactor is positioned at a bottom portion of the first reactor and in fluid communication with a second inlet of the second reactor and the one or more processes.

Embodiment 8. The reactor system according to any one of Embodiments 1-7, the first reactor further comprising a third inlet in fluid communication with an oxygen-providing material stream, the third inlet and the first outlet positioned at a bottom portion of the first reactor;
the second inlet and the first inlet located at a top portion of the first reactor; and
the second outlet located at a middle portion of the first reactor.

Embodiment 9. The reactor system according to any one of Embodiments 1-8, the first reactor further comprising a third inlet in fluid communication with an oxygen-providing material stream, the third inlet and the first outlet positioned at a bottom portion of the first reactor;
the first inlet and the second outlet positioned at a top portion of the first reactor; and
the second inlet positioned at a middle portion of the first reactor.

Embodiment 10. The reactor system according to any one of Embodiments 1-9, wherein the second reactor comprises a plurality of second inlets in fluid communication with the one or more processes, where the plurality of second inlets are arranged at different heights of the second reactor.

Embodiment 11. A reactor system, comprising:
a combustor reactor;
a riser in fluid communication with the combustor reactor;
a first gas-sealing device in fluid communication with the riser,
   the first gas-sealing device being in fluid communication with an inlet of a first gas source; and
   an outlet of the first gas-sealing device being in fluid communication with a first reducer;
a second gas-sealing device in fluid communication with the riser,
   the second gas-sealing device being in fluid communication with an inlet of a second gas source; and
   an outlet of the second gas-sealing device being in fluid communication with a second reducer;
the first reducer being in fluid communication with an inlet of a third gas-sealing device,
   the third gas-sealing device being in fluid communication with an inlet of a third gas source; and
   an outlet of the third gas-sealing device being in fluid communication with the combustor;
the second reducer being in fluid communication with an inlet of a fourth gas-sealing device,
   the fourth gas-sealing device being in fluid communication with an inlet of a fourth gas source; and
   an outlet of the fourth gas-sealing device being in fluid communication with an oxidizer reactor;
the oxidizer reactor being in fluid communication with a fifth gas-sealing device,
   the fifth gas-sealing device being in fluid communication with an inlet of a fifth gas source; and
   an outlet of the fifth gas-sealing device being in fluid communication with the combustor.

Embodiment 12. The reactor system according to Embodiment 11, wherein at least two of the first gas source, the second gas source, the third gas source, the fourth gas source, and the fifth gas source are a same gas source; and
the first reducer comprising:
   a first inlet in fluid communication with the outlet of the first gas-sealing device;
   a first outlet in fluid communication with the inlet of the fifth gas-sealing device;
   a second inlet configured to receive a carbonaceous fuel;
   a second outlet to provide syngas; and the second reducer comprising:
   a first inlet in fluid communication with the outlet of the second gas-sealing device;
   a first outlet in fluid communication with the inlet of the third gas-sealing device;
   a second inlet in fluid communication with the second outlet of the first reducer; and
   a second outlet configured to provide oxidation products.

Embodiment 13. The reactor system according to Embodiment 11 or Embodiment 12, the oxidizer reactor comprising:
a first inlet in fluid communication with the outlet of the fourth gas-sealing device;
a first outlet in fluid communication with the inlet of the fifth gas-sealing device;
a second inlet configured to receive steam; and
a second outlet configured to provide reduced products.

Embodiment 14. A method for operating a reactor system, the method comprising:
generating, in a first reactor, syngas and a plurality of first reduced oxygen carriers by reacting a carbonaceous feedstock with a plurality of first oxidized oxygen carriers;
providing the syngas from the first reactor to an inlet of one or more chemical processes;
generating, in a second reactor, oxidation products and a plurality of second reduced oxygen carriers by reacting waste gas with a plurality of second oxidized oxygen carriers;
generating, in a third reactor, hydrogen gas (H₂) and a plurality of reduced oxygen carriers by reacting oxygen-providing materials with the plurality of second reduced oxygen carriers;
providing the plurality of first reduced oxygen carriers from the first reactor to a reduced oxygen carrier stream, the reduced oxygen carrier stream being in fluid communication with a fourth reactor;
providing the plurality of reduced oxygen carriers from the third reactor to the reduced oxygen carrier stream;
generating, in the fourth reactor, oxidized oxygen carriers by reacting the reduced oxygen carrier stream with air;
providing oxidized oxygen carriers generated in the fourth reactor to the first reactor; and
providing oxidized oxygen carriers generated in the fourth reactor to the second reactor.

Embodiment 15. The method according to Embodiment 14, the method further comprising: providing the syngas from an outlet of the first reactor to an inlet of the second reactor.

Embodiment 16. The method according to Embodiment 14 or Embodiment 15, the method further comprising:
receiving the plurality of first oxidized oxygen carriers at a first inlet positioned at a top portion of the first reactor;
receiving the carbonaceous feedstock at a second inlet positioned near a top portion of the first reactor;
receiving, in cross-current flow, oxygen-providing materials at a third inlet positioned near a bottom portion of the first reactor; and
providing the syngas from an outlet positioned near a middle portion of the first reactor.

Embodiment 17. The method according to any one of Embodiments 14-16, the method further comprising:
providing, in co-current flow, the plurality of first oxidized oxygen carriers to a first inlet of the first reactor and the carbonaceous feedstock to a second inlet of the first reactor; and
providing, in counter-current flow, the plurality of second oxidized oxygen carriers to a first inlet of the second reactor and the waste gas to a second inlet of the second reactor.

Embodiment 18. The method according to any one of Embodiments 14-17, the method further comprising:

providing a fraction of oxidation products from an outlet of the second reactor to an inlet of the third reactor.

Embodiment 19. The method according to any one of Embodiments 14-18, wherein the oxygen-providing materials comprise steam (H₂O), air, oxygen (O₂), carbon dioxide (CO₂), and combinations thereof.

Embodiment 20. The method according to any one of Embodiments 14-19, the method further comprising:
operating the first reactor at a temperature between 500° C. and 1500° C. and at a pressure between 0 MPa and 5 MPa;
operating the second reactor at a temperature between 500° C. and 1500° C. and at a pressure between 0 MPa and 5 MPa;
operating the third reactor at a temperature between 500° C. and 1500° C. and at a pressure between 0 MPa and 5 MPa; and
operating the fourth reactor at a temperature between 500° C. to 1500° C. and at a pressure between 0 MPa to 5 MPa.

What is claimed is:

1. A reactor system, comprising:
a first reactor comprising:
a first inlet in fluid communication with an oxidized oxygen carrier stream;
a second inlet configured to receive carbonaceous feedstock;
a first outlet in fluid communication with a reduced oxygen carrier stream; and
a second outlet in fluid communication with one or more processes;
a second reactor comprising:
a first inlet in fluid communication with the oxidized oxygen carrier stream; and
a first outlet;
a third reactor comprising:
a first inlet in fluid communication with the first outlet of the second reactor;
a first outlet being in fluid communication with the reduced oxygen carrier stream;
the third reactor being in series with the second reactor; and
the first reactor being in parallel with the second reactor and the third reactor; and
a fourth reactor comprising:
an inlet in fluid communication with the reduced oxygen carrier stream;
an outlet in fluid communication with the oxidized oxygen carrier stream; and
the fourth reactor being configured as a fluidized bed reactor.

2. The reactor system according to claim 1, the second reactor further comprising:
a second inlet in fluid communication with a second outlet of the third reactor, the second reactor being in series with the third reactor; and
the second inlet configured to receive gases from the second outlet of the third reactor.

3. The reactor system according to claim 1, the system further comprising:
a plurality of first reactors, each of the plurality of first reactors comprising:
a first inlet in fluid communication with the oxidized oxygen carrier stream;
a first outlet in fluid communication with the reduced oxygen carrier stream; and
a second outlet in fluid communication with the one or more processes.

4. The reactor system according to claim 1, the system further comprising:
a plurality of second reactors, each of the plurality of second reactors comprising:
a first inlet in fluid communication with the oxidized oxygen carrier stream;
a first outlet in fluid communication with the third reactor;
a second inlet in fluid communication with the one or more processes; and
a second outlet configured to provide oxidation products.

5. The reactor system according to claim 4, the system further comprising:
a plurality of third reactors in series with the plurality of second reactors, each of the plurality of third reactors comprising:
a first inlet in fluid communication with one of the first outlets of the plurality of second reactors:
a second inlet configured to receive steam;
a first outlet in fluid communication with the reduced oxygen carrier stream; and
a second outlet configured to provide an outlet stream comprising hydrogen gas (H₂).

6. The reactor system according to claim 1, wherein a second outlet of the second reactor is in fluid communication with a second inlet of the third reactor.

7. The reactor system according to claim 1, wherein the second outlet of the first reactor is positioned at a bottom portion of the first reactor and in fluid communication with a second inlet of the second reactor and the one or more processes.

8. The reactor system according to claim 1, the first reactor further comprising a third inlet in fluid communication with an oxygen-providing material stream, the third inlet and the first outlet positioned at a bottom portion of the first reactor;
the second inlet and the first inlet located at a top portion of the first reactor; and
the second outlet located at a middle portion of the first reactor.

9. The reactor system according to claim 1, the first reactor further comprising a third inlet in fluid communication with an oxygen-providing material stream, the third inlet and the first outlet positioned at a bottom portion of the first reactor;
the first inlet and the second outlet positioned at a top portion of the first reactor; and
the second inlet positioned at a middle portion of the first reactor.

10. The reactor system according to claim 1, wherein the second reactor comprises a plurality of second inlets in fluid communication with the one or more processes, where the plurality of second inlets are arranged at different heights of the second reactor.

11. A reactor system, comprising:
a combustor reactor;
a riser in fluid communication with the combustor reactor;
a first gas-sealing device in fluid communication with the riser,
the first gas-sealing device being in fluid communication with an inlet of a first gas source; and
an outlet of the first gas-sealing device being in fluid communication with a first reducer;
a second gas-sealing device in fluid communication with the riser,
the second gas-sealing device being in fluid communication with an inlet of a second gas source; and
an outlet of the second gas-sealing device being in fluid communication with a second reducer;
the first reducer being in fluid communication with an inlet of a third gas-sealing device,
the third gas-sealing device being in fluid communication with an inlet of a third gas source; and
an outlet of the third gas-sealing device being in fluid communication with the combustor;
the second reducer being in fluid communication with an inlet of a fourth gas-sealing device,
the fourth gas-sealing device being in fluid communication with an inlet of a fourth gas source; and
an outlet of the fourth gas-sealing device being in fluid communication with an oxidizer reactor;
the oxidizer reactor being in fluid communication with a fifth gas-sealing device,
the fifth gas-sealing device being in fluid communication with an inlet of a fifth gas source; and
an outlet of the fifth gas-sealing device being in fluid communication with the combustor.

12. The reactor system according to claim 11, wherein at least two of the first gas source, the second gas source, the third gas source, the fourth gas source, and the fifth gas source are a same gas source; and
the first reducer comprising:
a first inlet in fluid communication with the outlet of the first gas-sealing device;
a first outlet in fluid communication with the inlet of the fifth gas-sealing device;
a second inlet configured to receive a carbonaceous fuel;
a second outlet to provide syngas; and
the second reducer comprising:
a first inlet in fluid communication with the outlet of the second gas-sealing device;
a first outlet in fluid communication with the inlet of the third gas-sealing device;
a second inlet in fluid communication with the second outlet of the first reducer; and
a second outlet configured to provide oxidation products.

13. The reactor system according to claim 11, the oxidizer reactor comprising:
a first inlet in fluid communication with the outlet of the fourth gas-sealing device;
a first outlet in fluid communication with the inlet of the fifth gas-sealing device;
a second inlet configured to receive steam; and
a second outlet configured to provide reduced products.

14. A method for operating a reactor system, the method comprising:
generating, in a first reactor, syngas and a plurality of first reduced oxygen carriers by reacting a carbonaceous feedstock with a plurality of first oxidized oxygen carriers;
providing the syngas from the first reactor to an inlet of one or more chemical processes;
generating, in a second reactor, oxidation products and a plurality of second reduced oxygen carriers by reacting waste gas with a plurality of second oxidized oxygen carriers;
generating, in a third reactor, hydrogen gas (H₂) and a plurality of reduced oxygen carriers by reacting oxygen-providing materials with the plurality of second reduced oxygen carriers;
providing the plurality of first reduced oxygen carriers from the first reactor to a reduced oxygen carrier stream, the reduced oxygen carrier stream being in fluid communication with a fourth reactor;
providing the plurality of reduced oxygen carriers from the third reactor to the reduced oxygen carrier stream;
generating, in the fourth reactor, oxidized oxygen carriers by reacting the reduced oxygen carrier stream with air;
providing oxidized oxygen carriers generated in the fourth reactor to the first reactor; and
providing oxidized oxygen carriers generated in the fourth reactor to the second reactor.

15. The method according to claim 14, the method further comprising:
providing the syngas from an outlet of the first reactor to an inlet of the second reactor.

16. The method according to claim 14, the method further comprising:
receiving the plurality of first oxidized oxygen carriers at a first inlet positioned at a top portion of the first reactor;
receiving the carbonaceous feedstock at a second inlet positioned near a top portion of the first reactor;
receiving, in cross-current flow, oxygen-providing materials at a third inlet positioned near a bottom portion of the first reactor; and
providing the syngas from an outlet positioned near a middle portion of the first reactor.

17. The method according to claim 14, the method further comprising:
providing, in co-current flow, the plurality of first oxidized oxygen carriers to a first inlet of the first reactor and the carbonaceous feedstock to a second inlet of the first reactor; and
providing, in counter-current flow, the plurality of second oxidized oxygen carriers to a first inlet of the second reactor and the waste gas to a second inlet of the second reactor.

18. The method according to claim 14, the method further comprising:
providing a fraction of oxidation products from an outlet of the second reactor to an inlet of the third reactor.

19. The method according to claim 14, wherein the oxygen-providing materials comprise steam (H₂O), air, oxygen (O₂), carbon dioxide (CO₂), and combinations thereof.

20. The method according to claim 14, the method further comprising:
operating the first reactor at a temperature between 500° C. and 1500° C. and at a pressure between 0 MPa and 5 MPa;
operating the second reactor at a temperature between 500° C. and 1500° C. and at a pressure between 0 MPa and 5 MPa;
operating the third reactor at a temperature between 500° C. and 1500° C. and at a pressure between 0 MPa and 5 MPa; and
operating the fourth reactor at a temperature between 500° C. to 1500° C. and at a pressure between 0 MPa to 5 MPa.
